(19) United States
(12) Patent Application Publication
(10) Pub. No.: US 2016/0278881 A1
(43) Pub. Date: Sep. 29, 2016

(54) MODULAR DENTAL RESTORATIVE MATERIAL DISPENSER AND METHODS OF MANUFACTURE

(71) Applicant: 3M Innovative Properties Company, Saint Paul, MN (US)

(72) Inventors: Bruce R. BROYLES, Oakdale, MN (US); Greg E. SCHRANK, Bloomington, MN (US)

(21) Appl. No.: 15/034,003

(22) PCT Filed: Nov. 5, 2014
(86) PCT No.: PCT/US2014/064110

§ 371 Date: May 3, 2016

Related U.S. Application Data
(60) Provisional application No. 61/900,787, filed on Nov. 6, 2013.

(51) Int. Cl. A61C 5/06

(52) U.S. Cl. CPC A61C 5/062

(57) ABSTRACT

Systems and methods of manufacturing dental restorative material packaged articles. A loaded barrel is retrieved from a plurality of identical loaded barrels, each including a universal barrel containing dental material and having a plunger coupling feature. A desired plunger assembly is selected from supplies of first and second plunger assemblies each including a plunger shaft, an auxiliary device, and a complimentary coupling feature. The first plunger assemblies differ from the second plunger assemblies. The selected plunger assembly is assembled to the loaded barrel, including engagement between the plunger coupling feature and the complimentary coupling feature. The resultant construction provides a packaged article that is operable to progressively dispense material by manipulation of the plunger assembly. Optionally, an outer sleeve and/or a cap is selected and assembled to the universal barrel. With the modular manufacturing methodologies, the universal barrel can be incorporated into a number of different fmal product configurations.

### BACKGROUND

The present disclosure relates to handheld dental restorative material dispenser packaging. More particularly, it relates to dental restorative material packaged dispenser designs conducive to mass production.

Many clinical dental procedures involve the application of a dental composite material onto one or more teeth of the patient. Oftentimes, the dental restorative material is viscous immediately prior to application (e.g., restoratives, core build up materials, etc.), and may harden once applied. These, and other, dental restorative materials are commonly provided to dentists in a reduced volume packaging that facilitates desired end-use techniques. As a point of reference, most clinical procedures require only a small total amount of dental restorative material, with the final applied volume typically created by sequential application of even smaller layers of the material. Because it is virtually impossible to know in advance the actual amount of material necessary for a particular procedure, dentists prefer to have a bulk supply of the material available. A bulk supply packaging format is cost-effective (as compared to a “single use” format) and when properly packaged (e.g., shielded from light and other environmental concerns), many dental restorative materials can have a relatively long shelf life. Thus, dentists prefer to purchase dental restorative materials in a handheld packaging format that contains and protects a supply of material sufficient to perform multiple procedures, and facilitates sequential retrieval of small quantities from the supply using a spatula or other application instrument. In this regard, cross-contamination concerns can arise where the application instrument repeatedly contacts the patient's mouth and the source supply, and the packaging format desirably accounts for this possibility.

One well-received dental restorative material packaging format that addresses all of the above concerns is akin to a conventional handheld syringe. As initially provided to the dentist, the syringe barrel maintains a supply volume of the dental restorative material sufficient to perform multiple procedures. The dispensing end of the barrel forms a relatively large opening through which a small amount of the supply volume can be incrementally dispensed (e.g., extruded) by manual operation of the syringe plunger. The extruded amount can then be applied to the patient as desired without risk of contaminating the remaining supply volume.

Syringe-type dental restorative material packaging (or “dispensers”) can assume a variety of forms, and can provide a number of different features. For example, syringe-type dispensers can incorporate plunger assemblies of varying shapes and/or complexity that in turn provide the user with different levels of precision or control over the dispensed amount. Also, some dentists strongly prefer that primary surfaces of the dispenser be contoured for ergonomic handling (that again can promote precise control over amounts dispensed), while others do not. Other surfaces of the dispenser (e.g., cap, handles, grips, etc.) can also be contoured or streamlined in accordance with the preferences of certain dentists.

Suppliers of the above-described dental restorative material dispensers endeavor to satisfy the preferences of different dentists and/or markets, and thus commonly offer packaged dispensers in varying formats. While this approach can meet the needs of multiple different end-users, it is not economically optimal. Each different dispenser format requires entirely discrete components and assembly lines. These factors, in turn, increase overall costs.

In light of the above, a need exists for improved dental restorative material packaging designs and corresponding methods of manufacture.

### SUMMARY

Some aspects of the present disclosure relate to a method of manufacturing dental restorative material packaged articles. The method includes selecting a first loaded syringe barrel from a plurality of loaded syringe barrels. The plurality of loaded syringe barrels are identical and each includes a barrel and a volume of dental restorative material. The barrel defines a leading end, a trailing end, and a chamber. Further, the barrel includes a plunger coupling feature adjacent the trailing end. The volume of dental restorative material is stored within the chamber. A desired plunger assembly is then selected from a plurality of first plunger assemblies and a plurality of second plunger assemblies. In this regard, all of the plunger assemblies include a plunger shaft and an auxiliary device, with at least one of the shaft and the auxiliary device providing a complimentary coupling feature configured to selectively engage the plunger coupling feature provided with each of the barrels. However, the plunger shaft provided with each of the first plurality of plunger assemblies differs from the plunger shaft provided with each of the second plurality of plunger assemblies and/or the auxiliary devices differ from one another. The desired plunger assembly is then assembled to the selected loaded syringe barrel, including engagement between the plunger coupling feature of the barrel with the complimentary coupling feature of the plunger assembly. The resultant construction provides a dental restorative material packaged article that is operable to progressively dispense a quantity of the volume of dental restorative material by manual manipulation of the plunger assembly. The methods of the present disclosure provide significant manufacturing efficiency as compared to the conventional approach of having separate and distinct barrel designs for each product configuration.

With the methods of the present disclosure, then, the barrel associated with each of the plurality of loaded syringe barrels has a universal construction, conducive to assembly with either of the differently-configured plunger assemblies. In some embodiments, the method further includes selecting an outer sleeve from a supply of at least two different outer sleeve constructions, and applying the so-selected outer sleeve to an exterior of the select loaded syringe barrel. In related embodiments, a cap is selected from a supply of at least two different cap designs and is connected to the selected loaded syringe barrel. With the modular manufacture methodologies of the present disclosure, a universal syringe barrel can be incorporated into a variety of different finished products. Economies of scale can be gained by using large cavitation injection molds to manufacture the loaded syringe barrels and automated filling of the dental restorative materials into the barrel. The loaded syringe barrels can then be further assembled with a variety of different components to create drastically different looking and operating dispensers as desired by different market segments.

### BRIEF DESCRIPTION OF THE DRAWINGS

FIG. 1 is a block diagram illustrating a system for manufacturing dental restorative material packaged articles in accordance with principles of the present disclosure;

FIG. 2 is a flow chart of methods of manufacturing dental restorative material packaged articles in accordance with principles of the present disclosure;

FIG. 3A is a perspective view of a universal barrel useful with systems and methods of the present disclosure;

FIG. 3B is a cross-sectional view of the universal barrel of FIG. 3A;

FIG. 4 is a cross-sectional view of a loaded syringe barrel useful with systems and methods of the present disclosure and including the universal barrel of FIG. 3A;

FIG. 5 is an exploded perspective view of a plunger assembly configured for use with the universal barrel of FIG. 3A in connection with systems and methods of the present disclosure;

FIG. 6 is an enlarged, cross-sectional view of an auxiliary component of the plunger assembly of FIG. 5;

FIG. 7 is a cross-sectional view of a dental restorative material packaged article in accordance with principles of the present disclosure including the universal barrel of FIG. 3A and the plunger assembly of FIG. 5;

FIG. 8 is an exploded perspective view of another plunger assembly configured for use with the universal barrel of FIG. 3A in connection with systems and methods of the present disclosure;

FIG. 9 is an enlarged, cross-sectional view of an auxiliary component of the plunger assembly of FIG. 8;

FIG. 10 is a cross-sectional view of a dental restorative material packaged article in accordance with principles of the present disclosure including the universal barrel of FIG. 3A and the plunger assembly of FIG. 8;

FIG. 11 is an exploded perspective view of another plunger assembly configured for use with the universal barrel of FIG. 3A in connection with systems and methods of the present disclosure;

FIG. 12 is an enlarged, cross-sectional view of an auxiliary component of the plunger assembly of FIG. 11;

FIG. 13 is a cross-sectional view of a dental restorative material packaged article in accordance with principles of the present disclosure including the universal barrel of FIG. 3A and the plunger assembly of FIG. 11;

FIG. 14A is a perspective view of an outer sleeve configured for use with the universal barrel of FIG. 3A in connection with systems and methods of the present disclosure;

FIG. 14B is a cross-sectional view of the outer sleeve of FIG. 14A;

FIG. 15 is a cross-section view of the outer sleeve of FIG. 14A mounted to the universal barrel of FIG. 3A;

FIG. 16A is a perspective view of another outer sleeve configured for use with the universal barrel of FIG. 3A in connection with systems and methods of the present disclosure;

FIG. 16B is a cross-sectional view of the outer sleeve of FIG. 16A;

FIG. 17 is a cross-section view of the outer sleeve of FIG. 16A mounted to the universal barrel of FIG. 3A;

FIG. 18 is a perspective view of a cap configured for use with the universal barrel of FIG. 3A in connection with systems and methods of the present disclosure;

FIG. 19 is a perspective view of another cap configured for use with the universal barrel of FIG. 3A in connection with systems and methods of the present disclosure;

FIG. 20 is a perspective view of another cap configured for use with the universal barrel of FIG. 3A in connection with systems and methods of the present disclosure;

FIG. 21A illustrates exemplary dental restorative material packaged articles manufactured in accordance with principles of the present disclosure and commonly incorporating the universal barrel of FIG. 3A;

FIG. 21B is simplified schematic illustration of a modular manufacturing system in accordance with principles of the present disclosure in manufacturing two of the packaged articles of FIG. 21A

FIG. 22A is a perspective view of another universal barrel useful with systems and methods of the present disclosure;

FIG. 22B is a cross-sectional view of the universal barrel of FIG. 22A;

FIG. 23 is a cross-sectional view of a loaded syringe barrel useful with systems and methods of the present disclosure and including the universal barrel of FIG. 22A;

FIG. 24 is an exploded perspective view of a plunger assembly configured for use with the universal barrel of FIG. 22A in connection with systems and methods of the present disclosure;

FIG. 25 is an enlarged, cross-sectional view of an auxiliary component of the plunger assembly of FIG. 24;

FIG. 26 is a cross-sectional view of a dental restorative material packaged article in accordance with principles of the present disclosure including the universal barrel of FIG. 22A and the plunger assembly of FIG. 24;

FIG. 27 is an exploded perspective view of another plunger assembly configured for use with the universal barrel of FIG. 22A in connection with systems and methods of the present disclosure;

FIG. 28 is an enlarged, cross-sectional view of an auxiliary component of the plunger assembly of FIG. 27;

FIG. 29 is a cross-sectional view of a dental restorative material packaged article in accordance with principles of the present disclosure including the universal barrel of FIG. 22A and the plunger assembly of FIG. 27;

FIGS. 30A and 30B illustrate exemplary dental restorative material packaged articles manufactured in accordance with principles of the present disclosure and commonly incorporating the universal barrel of FIG. 22A;

FIG. 31 is a perspective view of another dental restorative material packaged article in accordance with principles of the present disclosure;

FIG. 32 is a perspective view of another dental restorative material packaged article in accordance with principles of the present disclosure;

FIG. 33A is a perspective view of another dental restorative material packaged article in accordance with principles of the present disclosure; and

FIG. 33B is an enlarged view of a portion of the packaged article of FIG. 33A.

### DETAILED DESCRIPTION

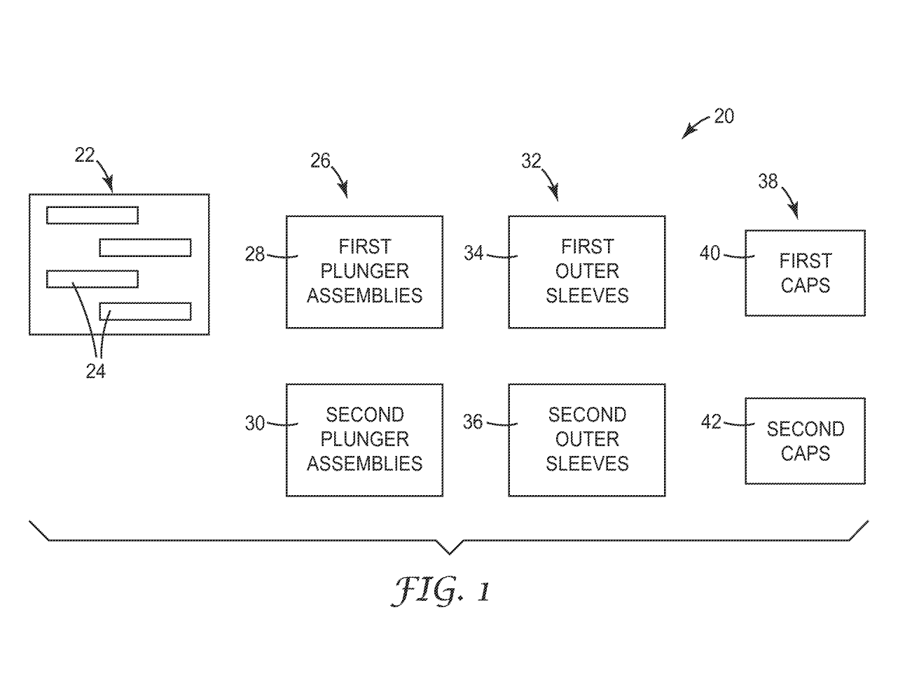

One embodiment of a system 20 for manufacturing dental restorative material packaged articles in accordance with principles of the present disclosure is schematically shown in FIG. 1. In general terms, the manufacturing system 20 includes a supply 22 of loaded syringe barrels 24 and a supply 26 of plunger assemblies. The loaded syringe barrels 24 provided with the supply 22 are identical, and each includes a universal barrel loaded with a volume of dental restorative material. The supply 26 of plunger assemblies includes at least a plurality of first plunger assemblies 28 and a plurality of second plunger assemblies 30. A plurality of additional plunger assemblies (differing from the first plunger assemblies 28 and the second plunger assemblies 30) can also be available. The first plunger assemblies 28 are all identical, as are the second plunger assemblies 30. However, the first plunger assemblies 28 differ from the second plunger assemblies 30 in one or more aspects, with all of the plunger assemblies 28, 30 being configured for engagement with a plunger coupling feature commonly provided with each of the loaded syringe barrels 24. Thus, the loaded syringe barrels 24 have a universal design feature(s) that is complimented by a corresponding design feature incorporated into all of the first and second plunger assemblies 28, 30. In other embodiments of the manufacturing system 20, a supply 32 of outer sleeves is available, optionally including at least a plurality of first outer sleeves 34 and a plurality of second outer sleeves 36. Although differing from one another in certain respects, each of the first and second outer sleeves 34, 36 is commonly configured for assembly to a universal design feature of the loaded syringe barrels 24. In yet other embodiments, a supply 38 of caps is optionally provided with the manufacturing system 20, including at least a plurality of first caps 40 and a plurality of second caps 42. Although differing from one another in certain respects, each of the first and second caps 40, 42 is commonly configured for assembly to a universal design feature of the loaded syringe barrels 24.

As evidenced by the above descriptions, dental restorative material packaged article manufacturing systems and methods in accordance with principles of the present disclosure are modular in nature, and can be premised upon the provision of the universal loaded syringe barrels 24. In this regard, the loaded syringe barrels 24, as well as other components of resultant dental restorative packaged articles (e.g., plunger assembly, optional sleeve, optional cap, etc.), can assume various forms as described below so long as complimentary coupling features are incorporated into the configuration of each component. Thus, many of the individual design attributes described elsewhere relative to exemplary component embodiments are not critical to the dental restorative material packaged article manufacturing systems and methods of the present disclosure.

### Modular Methods of Manufacture

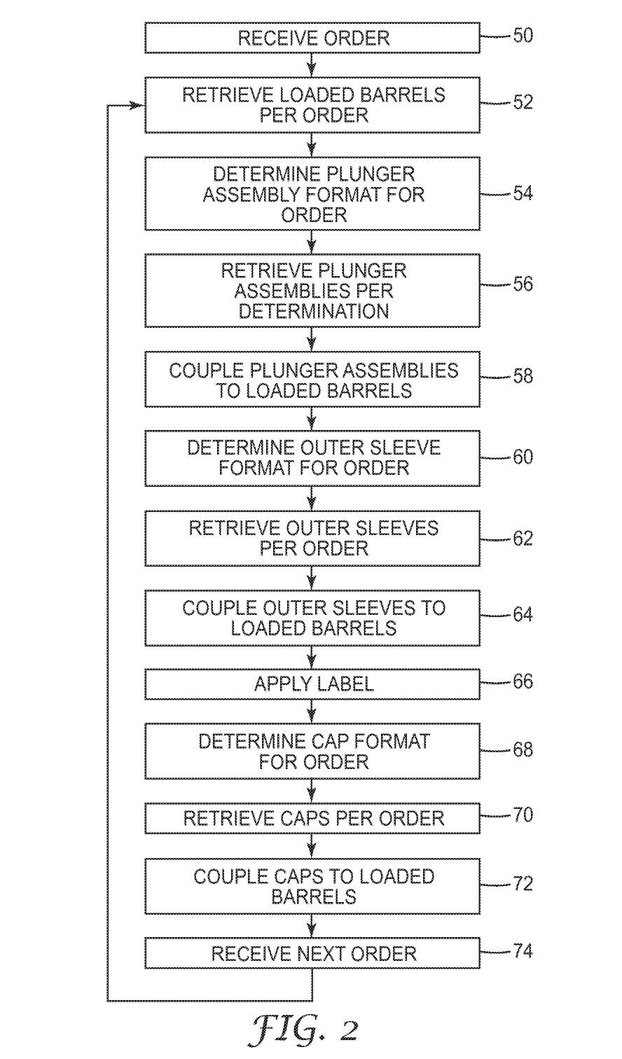

The modular characteristics of the manufacturing systems and methods of the present disclosure are reflected by FIG. 2 that otherwise provides a block diagram of the steps in carrying out the manufacturing methods of some embodiments of the present disclosure, for example in filling multiple orders for dental restorative material packaged articles on a mass production basis. With cross reference between FIGS. 1 and 2, the manufacturer, at step 50, receives a first order for a plurality of dental restorative material packaged articles of a first configuration from a customer. As a point of reference, the manufacturer can have available for purchase two (or more) different versions of dental restorative material packaged articles (each containing the same dental restorative material, but with differing packaging). The manufacturer, at step 52, retrieves a corresponding number of loaded syringe barrels 24 from the supply 22 of loaded syringe barrels. The first order is further reviewed to determine the plunger assembly format implicated by the first order at step 54. For example, the packaged articles of the first order can implicate either the first plunger assemblies 28 or the second plunger assemblies 30 (or other plunger assembly designs available with the manufacturing system 20). A corresponding number of the so-implicated or desired plunger assemblies are retrieved from the supply 26 of plunger assemblies at step 56 (e.g., where the first order implicates the plurality of first plunger assemblies 28, a corresponding number of the first plunger assemblies 28 sufficient to complete the first order are retrieved from the supply 26 of plunger assemblies). Respective ones of the retrieved plunger assemblies are then coupled to corresponding ones of the retrieved loaded syringe barrels 24 at step 58 via the complimentary coupling features described below. In some embodiments, following assembly at step 58, the dental restorative material packaged articles are complete and can be delivered to the customer.

In some optional embodiments, the supply 32 of outer sleeves is available. At step 60, the manufacturer reviews the first order to determine whether the provision of an outer sleeve is implicated, and if so, the corresponding outer sleeve format. If an outer sleeve is required, a corresponding number of the so-implicated or desired outer sleeves are retrieved from the supply 32 at step 62 (e.g., where the first order implicates the plurality of first outer sleeves 34, a corresponding number of the first outer sleeves 34 sufficient to complete the first order are retrieved from the supply 32 of outer sleeves). Respective ones of the retrieved outer sleeves are then coupled to corresponding ones of the retrieved loaded syringe barrels 24 at step 64 via complimentary coupling features described below. Step 66 reflects that a label can optionally be applied to each of the outer sleeves; in other constructions where the outer sleeve is not included, the label can optionally be applied directly to each of the retrieved loaded syringe barrels 24. In yet other embodiments, the label is omitted.

In some optional embodiments, the supply 38 of caps is available. At step 68, the manufacturer reviews the first order to determine whether the provision of a cap is implicated, and if so, the corresponding cap format. If a cap is required, a corresponding number of the so-implicated or desired caps are retrieved from the supply 38 at step 70 (e.g., where the first order implicates the plurality of first caps 40, a corresponding number of the first caps 40 sufficient to complete the first order are retrieved from the supply 38 of caps). Respective ones of the retrieved caps are then coupled to the corresponding ones of the retrieved loaded syringe barrels 24 at step 72 via complimentary coupling features described below.

Following coupling of the selected plunger assemblies to corresponding ones of the retrieved loaded syringe barrels 24, and optional assembly of the retrieved outer sleeves and/or caps to corresponding ones of the retrieved loaded syringe barrels 24, a sufficient number of properly constructed dental restorative material packaged articles are now ready for delivery to the customer in fulfillment of the first order. At step 74, a second order is received by the manufacturer for a plurality of dental restorative material packaged articles of a second configuration from a customer. The dental restorative material packaged articles of the second order entail the same dental restorative material as the first order, but a different packaging scheme. To fill this order, the method returns to step 52, at which a corresponding number of the loaded syringe barrels 24 are retrieved from the supply 22. The plunger assembly, and optionally the outer sleeve and/or cap, implicated by the second order differ from the first order. For example, the packaged article configuration of the second order can entail the second plunger assemblies 30 (instead of the first plunger assemblies 28 of the first order). However, the manufacturer can quickly meet the requirements of the second order by retrieving and then assembling the corresponding component(s) to the loaded syringe barrels 24 retrieved from the same common supply 22. Simply stated, the universal nature of the loaded syringe barrels 24 in combination with the complimentary coupling features incorporated into each version of the remaining packaged article components allows the manufacturer to easily manufacture drastically different looking dental restorative material packaged articles on a highly cost-effective basis as required for different market segments.

### Loaded Syringe Barrel

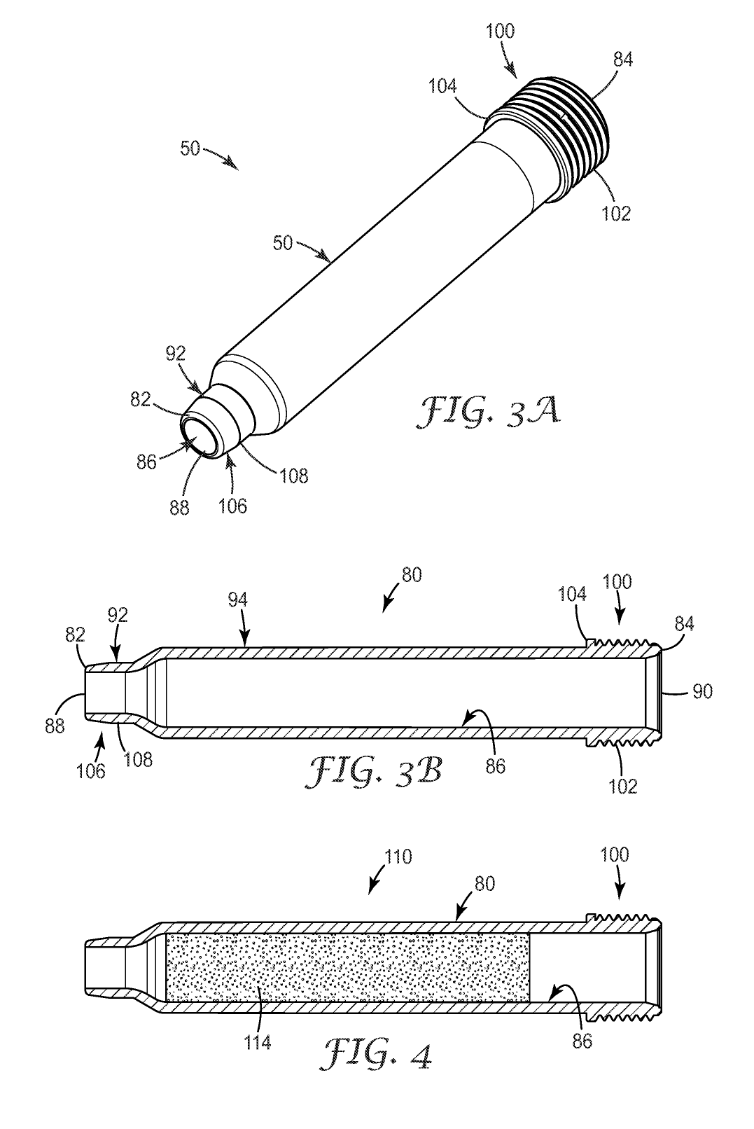

In general terms, the loaded syringe barrel 24 consists of a universal barrel filled with a volume of dental restorative material. With this mind, one embodiment of a universal syringe barrel 80 useful with the manufacturing systems and methods of the present disclosure is shown in FIGS. 3A-3B. The universal barrel 80 can be a homogeneous, integrally formed body and defines a leading end 82, a trailing end 84, and a chamber 86. The chamber 86 is sized to receive and contain a volume of dental restorative material (not shown), and extends between openings 88, 90 defined at the leading and trailing ends 82, 84, respectively.

The universal barrel 80 can have a generally cylindrical shape, for example defined by a tip region 92 and a containment region 94. The tip region 92 extends from the leading end 82, and can define an outer diameter (or other dimension) that is less than (or tapered from) an outer diameter of the containment region 94. In some embodiments, the containment region 94 is a simple cylinder in shape, with an exterior surface 96 thereof being substantially smooth or free of surface contours.

The universal barrel 80 further includes or defines a plunger coupling feature 100 adjacent the trailing end 84. The plunger coupling feature 100 is configured for engagement with a complimentary coupling feature provided with the plunger assemblies 28, 30 (FIG. 1) as described below, and in some embodiments is an exterior threaded surface 102 formed on the exterior surface 96 of the universal barrel 80. Alternatively, the plunger coupling feature 100 can assume a variety of other forms. In some constructions, though, the plunger coupling feature 100 is selected so as to be conducive to integral formation with a remainder of the universal barrel 80. With embodiments in which the plunger coupling feature 100 includes the exterior threaded surface 102, a flange 104 can also be included, and defines an end or stop to the exterior threaded surface 102.

The universal barrel 80 optionally forms a second coupling feature 106 adjacent the leading end 82. The second coupling feature 106 is generally configured for universal connection with any of the caps 40, 42 (FIG. 1), and in some embodiments can be a ridge 108 formed along an exterior of the tip region 92.

As shown in FIG. 4, a loaded syringe barrel 110 useful as the loaded syringe barrels 24 (FIG. 1) of the supply 22 (FIG. 1) can be formed by filling or loading a volume 112 of dental restorative material 114 into the chamber 86 of universal barrel 80. The dental restorative material 114 can assume a variety of forms commonly employed for clinical dental procedures, and is generally a viscous material or paste such as restorative composition, adhesive composition, dental cement, dental filler, etc. In some embodiments, the dental restorative material 114 is radiation-reactive (i.e., light radiation curable). With these and similar embodiments, the universal barrel 80 is formed from a material(s) selected to block light from interacting with the volume 112 of the dental restorative material 114 contained within the chamber 86. Regardless, the dental restorative material 114 can be loaded into the chamber 86 in various fashions, for example via an automated filling device.

Plunger Assemblies Useful with the Universal Barrel 80

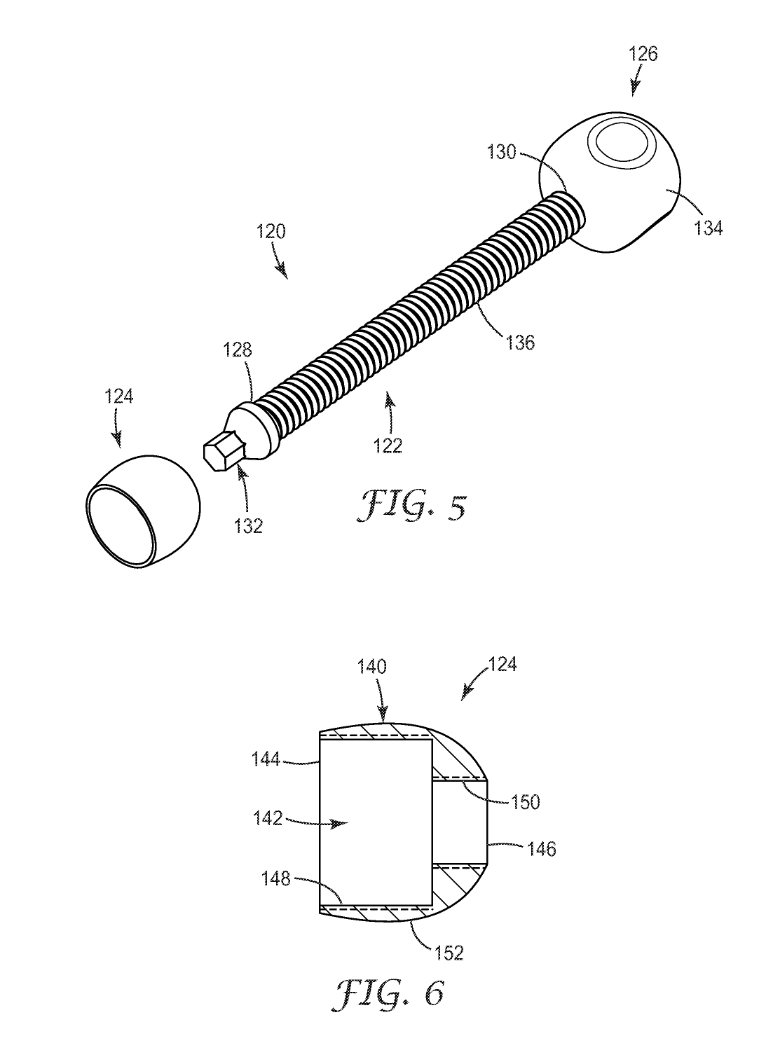

As implicated by the above, the remaining components of the manufacturing system 20 (FIG. 1) are configured in accordance with the engagement feature(s) provided with the universal barrel 80. For example, each of the first plunger assemblies 28 (FIG. 1) and the second plunger assemblies 30 (FIG. 1) commonly include a complimentary coupling feature configured to engage (e.g., threadably engage) the plunger coupling feature 100. However, other features provided with the available plunger assemblies can incorporate a variety of other or different design features. For example, FIG. 5 illustrates one embodiment of a plunger assembly 120 configured for use with the universal barrel 80 (FIG. 3A) and representative of one of the first or second plunger assemblies 28, 30 (FIG. 1). The plunger assembly 120 includes a plunger shaft 122, a first auxiliary device 124 and a second auxiliary device 126. At least one of the plunger shaft 122 or the auxiliary devices 124, 126 forms a complimentary coupling feature configured to connect with the plunger coupling feature 100 (FIG. 3A) provided with the universal barrel 80 (FIG. 3A). With the exemplary embodiment of FIG. 5, the first auxiliary device 124 incorporates the complimentary coupling feature as described below.

The plunger shaft 122 can assume various forms, and extends between a piston end 128 and a handle end 130 (referenced generally). The piston end 128 is configured for connection to, or alternatively forms, a piston member 132 in some embodiments.

Conversely, the handle end 130 is configured for assembly to the second auxiliary device 126 that, with the embodiment of FIG. 5, is a handle in the form of a knob 134. Regardless, the plunger shaft 122 forms or defines an exterior threaded surface 136. With this construction, the piston member 132 and/or the knob 134 can be configured to threadably engage the exterior threaded surface 136 upon final construction of the plunger assembly 120.

The first auxiliary device 124 is shown in greater detail in FIG. 6, and can be generally formed as a nut or nut-like body 140. The nut 140 forms a central passageway 142 extending between first and second ends 144, 146. A diameter of the central passageway 142 adjacent the first end 144 is greater than that at the second end 146. Further, the nut 140 forms a first interior threaded surface 148 (drawn generally) adjacent the first end 144 that serves as the complimentary coupling feature of the plunger assembly 120. More particularly, the first interior threaded surface 148 is configured to threadably engage the exterior threaded surface 102 (FIG. 3A) of the universal barrel 80 (FIG. 3A). A second interior threaded surface 150 (drawn generally) is formed adjacent the second end 146 and extends along the reduced diameter portion of the central passageway 142. The second interior threaded surface 150 is configured to threadably engage the exterior threaded surface 136 (FIG. 5) of the plunger shaft 122 (FIG. 5). An exterior surface 152 of the nut 140 can have the smooth, streamlined shape as shown.

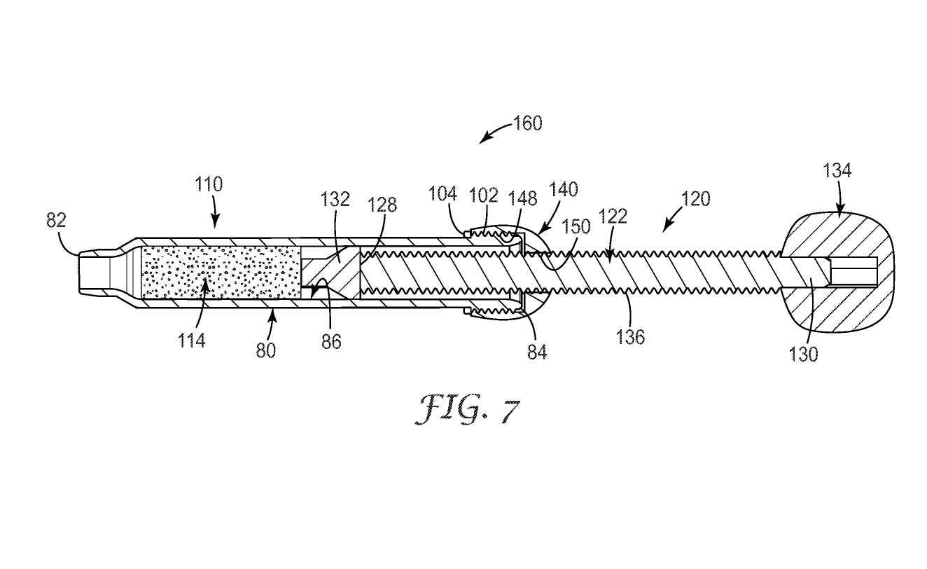

Mounting of the plunger assembly 120 to the loaded syringe barrel 110 is shown in FIG. 7, with the final assembly representing one embodiment of a dental restorative material packaged article 160 in accordance with the present disclosure. As shown, the plunger shaft 122 is arranged relative to the universal barrel 80 such that the piston end 128 (and the optional piston member 132 attached thereto) is disposed within the chamber 86 via the trailing end 84. The nut 140 couples the plunger shaft 122 to the universal barrel 80. More particularly, the complimentary coupling features of the universal barrel 80 and the plunger assembly 120 are engaged with one another, for example with the first interior threaded surface 148 of the nut 140 threadably engaged with the exterior threaded surface 102 of the universal barrel 80. Where provided, the flange 104 serves as a stop to the threaded coupling. The exterior threaded surface 136 of the plunger shaft 122 is threadably engaged with the second interior threaded surface 150 of the nut 140. In this regard, the assembled state of FIG. 7 can be achieved by assembling the nut 140 to the universal barrel 80 and the plunger shaft 122 prior to mounting of the knob 134 to the handle end 130. Regardless, the dental restorative material 114 can be progressively dispensed through the leading end 82 of the universal barrel 80 by user-caused rotation of the plunger shaft 122 (e.g., via the knob 134) in a direction that causes the piston end 128 to advance toward the leading end 82.

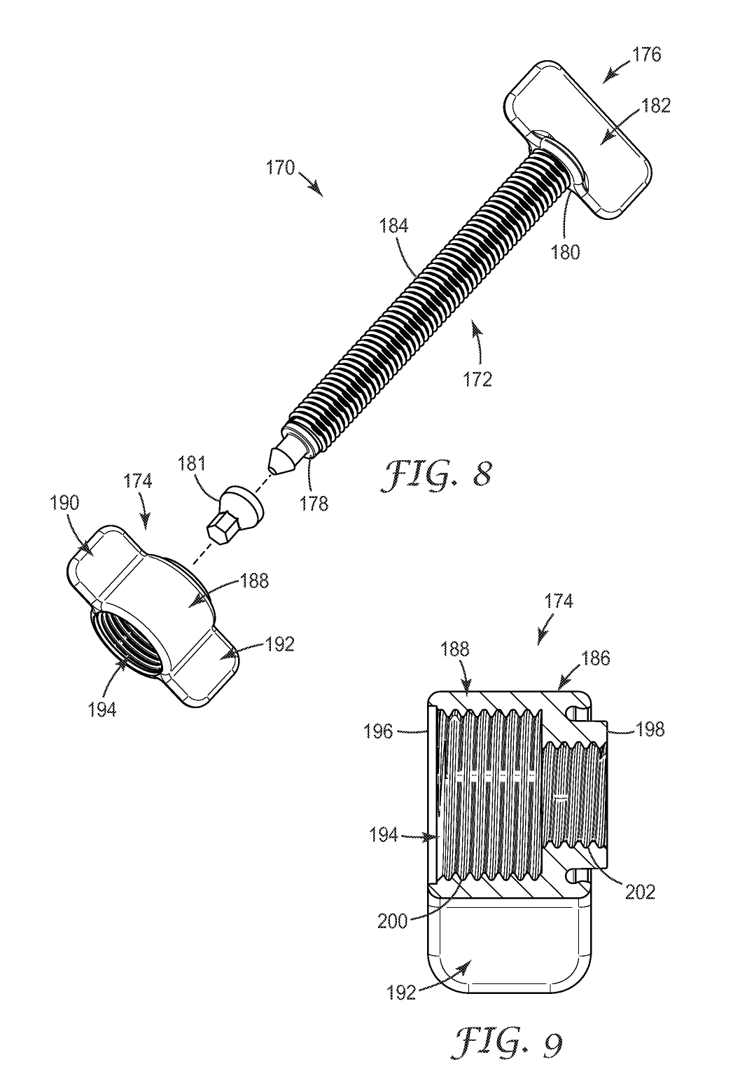

Another embodiment plunger assembly 170 configured for use with the universal barrel 80 (FIG. 3A) and representative of one of the first or second plunger assemblies 28, 30 (FIG. 1) is shown in FIG. 8. The plunger assembly 170 includes a plunger shaft 172, a first auxiliary device 174, and a second auxiliary device 176. At least one of the shaft 172 or auxiliary devices 174, 176 forms or provides a complimentary coupling feature configured to engage the plunger coupling feature 100 (FIG. 3A) provided with the universal barrel 80.

The plunger shaft 172 can be highly similar to the plunger shaft 122 (FIG. 6) described above, and extends between a piston end 178 and a handle end 180 (referenced generally). The piston end 178 can form or is configured for connection to a piston member 181. The handle end 180 is configured for assembly to the second auxiliary device 176 that, in some embodiments, is a handle in the form of a flattened knob 182. Finally, the plunger shaft 172 forms an exterior threaded surface 184 for reasons made clear below. The knob 182 can be configured for threadable engagement with the exterior threaded surface 184. In other embodiments, the knob 184 is integrally formed with the plunger shaft 172.

The first auxiliary device 174 is a shown in greater detail in FIG. 9, and can assume the form of a wing nut or wing nut-like body 186. The wing nut 186 includes or defines a central portion 188 and opposing fingers 190, 192 (best shown in FIG. 8). The fingers 190, 192 project from opposite sides of the central portion 188, and provide a convenient surface for grasping by a user. The central portion 188, in turn, forms a passageway 194 extending between first and second ends 196, 198. A diameter of the passageway 194 adjacent the first end 196 is greater than that adjacent the second end 198. Further, the central portion 188 forms a first interior threaded surface 200 adjacent the first end 196 and that serves as the complimentary coupling feature of the plunger assembly 170. More particularly, the first interior threaded surface 200 is configured to threadably engage the exterior threaded surface 102 (FIG. 3A) provided with the universal barrel 80 (FIG. 3A). The wing nut 186 further forms or defines a second interior threaded surface 202 configured to threadably engage the exterior threaded surface 184 of the plunger shaft 172.

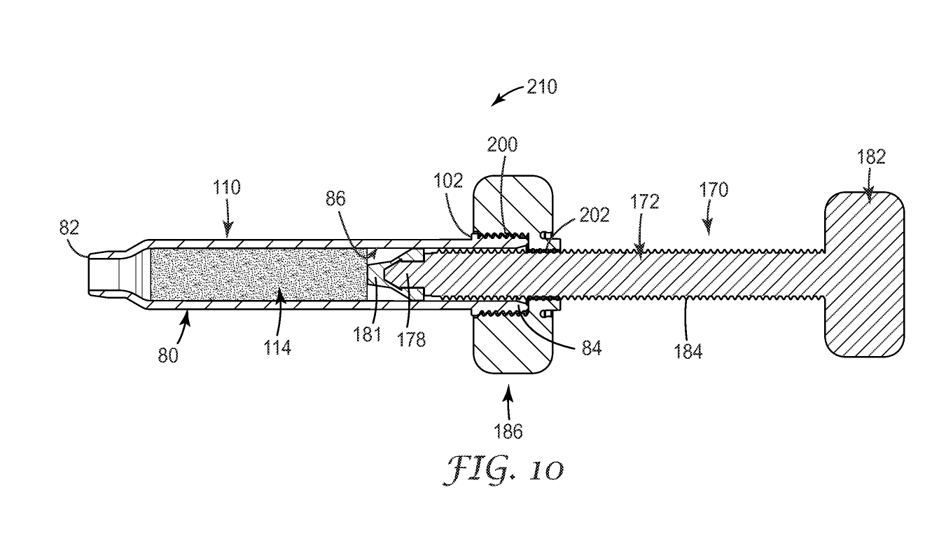

Mounting of the plunger assembly 170 to the loaded syringe barrel 110 in forming a dental restorative material packaged article 210 in accordance with principles of the present disclosure is shown in FIG. 10. The plunger shaft 172 is arranged relative to the universal barrel 80 such that the piston end 178 (and the piston member 181) is disposed within the chamber 86 via the trailing end 84. The wing nut 186 connects the plunger shaft 172 to the universal barrel 80. More particularly, the complimentary coupling features provided with the universal barrel 80 and the plunger assembly 170 are connected to one another (i.e., the first interior threaded surface 200 of the wing nut 186 threadably engages the exterior threaded surface 102 of the universal barrel 80). Further, the exterior threaded surface 184 of the plunger shaft 172 is threadably engaged with the second interior threaded surface 202 of the wing nut 186. With this construction, the dental restorative material 114 can be progressively dispensed through the leading end 82 of the universal barrel 80 by user-caused rotation of the plunger shaft 172 in a direction that causes the piston end 178 to advance toward the leading end 82 (via threaded interface with the wing nut 186 that otherwise remains stationary relative to the universal barrel 80 with rotation of plunger shaft 172).

Another embodiment plunger assembly 220 configured for use with the universal barrel 80 and representative of one of the first or second plunger assemblies 28, 30 (FIG. 1) is shown in FIG. 11. The plunger assembly 220 includes a plunger shaft 222, a first auxiliary device 224 and a second auxiliary device 226. At least one of the plunger shaft 222 or the first and second auxiliary devices 224, 226 forms a complementary coupling feature configured to engage with the plunger coupling feature 100 (FIG. 3A) provided with the universal barrel 80 (FIG. 3A) as described below.

The plunger shaft 222 can be similar to the plunger shafts described above, and defines a piston end 230 and a handle end 232. The piston end 230 can form, or is configured for assembly to, a piston member 233. The handle end 232 is configured for receiving, or integrally forms, the second auxiliary device 226. With the exemplary embodiment of FIG. 11, the second auxiliary device 226 is a handle in the form of a loop body 234. Finally, the plunger shaft 222 forms an exterior threaded surface 236. The loop body 234 can be constructed to threadably engage the exterior threaded surface 236 at the handle end 232.

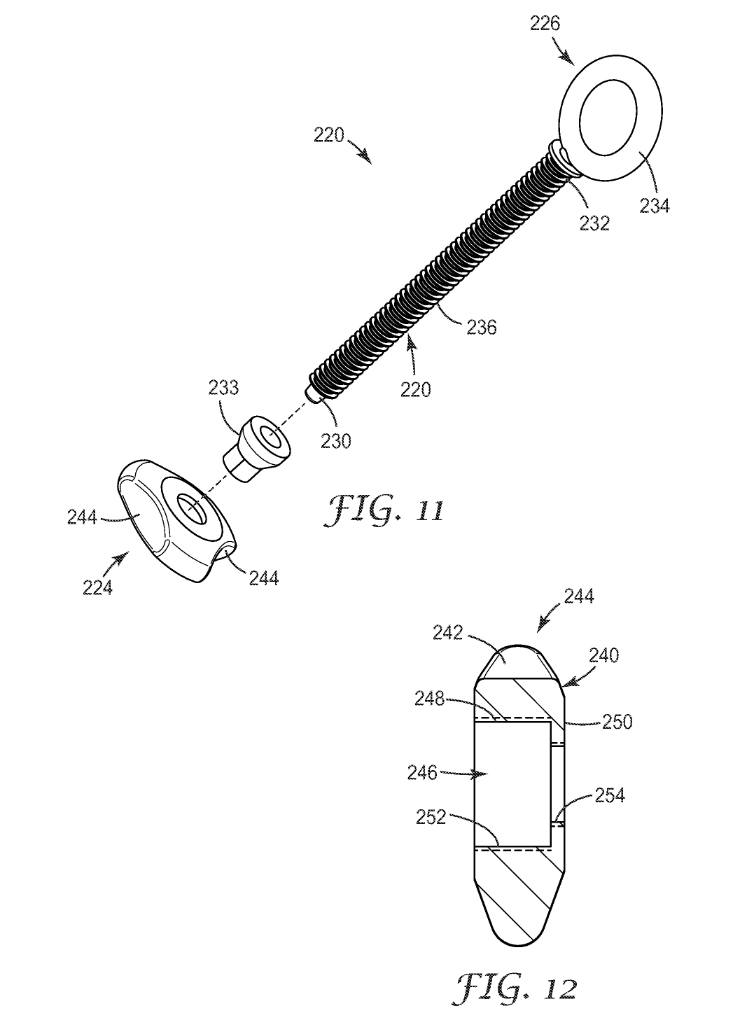

The first auxiliary device 224 is shown in greater detail in FIG. 12, and is generally constructed as a nut or nut-like body 240. The nut 240 defines a contoured outer surface 242 that can form gripping regions 244 (best shown in FIG. 11) that promote convenient, ergonomic handling by a user. Regardless, the nut 240 further defines a passageway 246 extending from a first end 248 to a second end 250. The passageway 246 has an elevated diameter adjacent the first end 248 as compared to a diameter adjacent the second end 250. A first interior threaded surface 252 (drawn generally) is formed adjacent the first end 248 and serves as the complementary coupling feature of the plunger assembly 220. More particularly, the first interior threaded surface 252 is configured to threadably engage the exterior threaded surface 102 (FIG. 3A) of the universal barrel 80 (FIG. 3A). A second interior threaded surface 254 (drawn generally) is formed adjacent the second end 250, and is adapted to threadably engage the exterior threaded surface 236 of the plunger shaft 222.

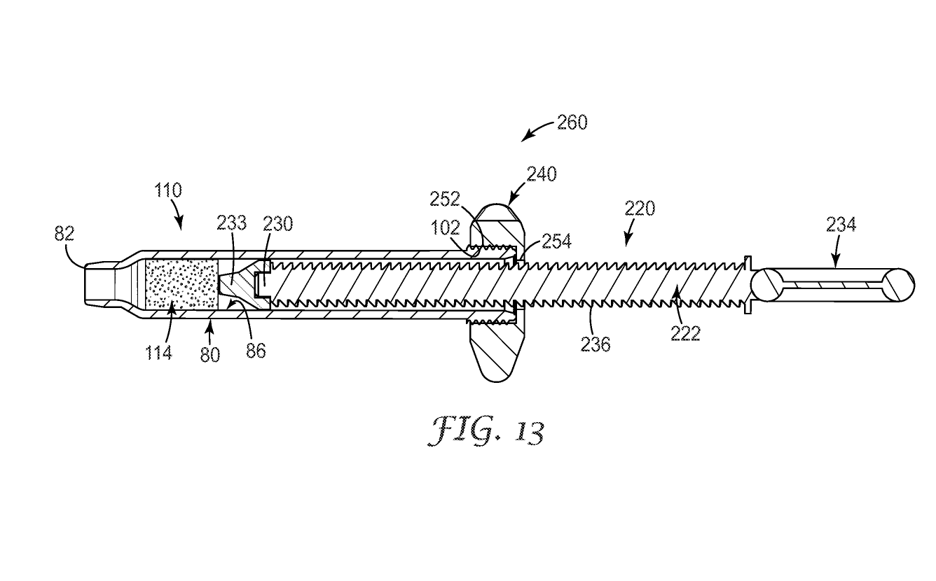

Mounting of the plunger assembly 220 to the loaded syringe barrel 110 to form another embodiment dental restorative material packaged assembly 260 in accordance with principles of the present disclosure is shown in FIG. 13. The plunger shaft 222 is arranged relative to the universal barrel 80 such that the plunger end 230 is disposed within the chamber 86. The nut 240 maintains the plunger shaft 222 relative to the universal barrel 80. More particularly, the nut 240 is assembled to the universal barrel 80 via the corresponding coupling features (i.e., the first interior threaded surface 252 of the nut 240 is threadably engaged to the exterior threaded surface 102 of the universal barrel 80). Further, the plunger shaft 222 is threadably secured to the nut 240 via threaded engagement between the threaded surfaces 236, 254. With this construction, the dental restorative material 114 maintained within the chamber 86 can be progressively dispensed through the leading end 82 by rotation of the plunger shaft 222 (e.g., user-applied rotation at the loop 234). In this regard, the nut 240 and the universal barrel 80 remain stationary during rotation of the plunger shaft 222, with the piston end 230 (and the piston member 233) thus advancing toward the leading end 82.

Sleeves Useful with the Universal Barrel 80

Returning to FIG. 1, in some embodiments of the present disclosure, the dental restorative material packaged article manufacturing system 20 and corresponding methods of manufacture further includes an outer sleeve, with the supply 32 of outer sleeves optionally including two (or more) differently formatted outer sleeve constructions. Where provided, the outer sleeves and the loaded syringe barrels 24 have complementary features that facilitate their assembly. That is to say, the loaded syringe barrels 24 are universally designed for coupling with any of the provided outer sleeve formats.

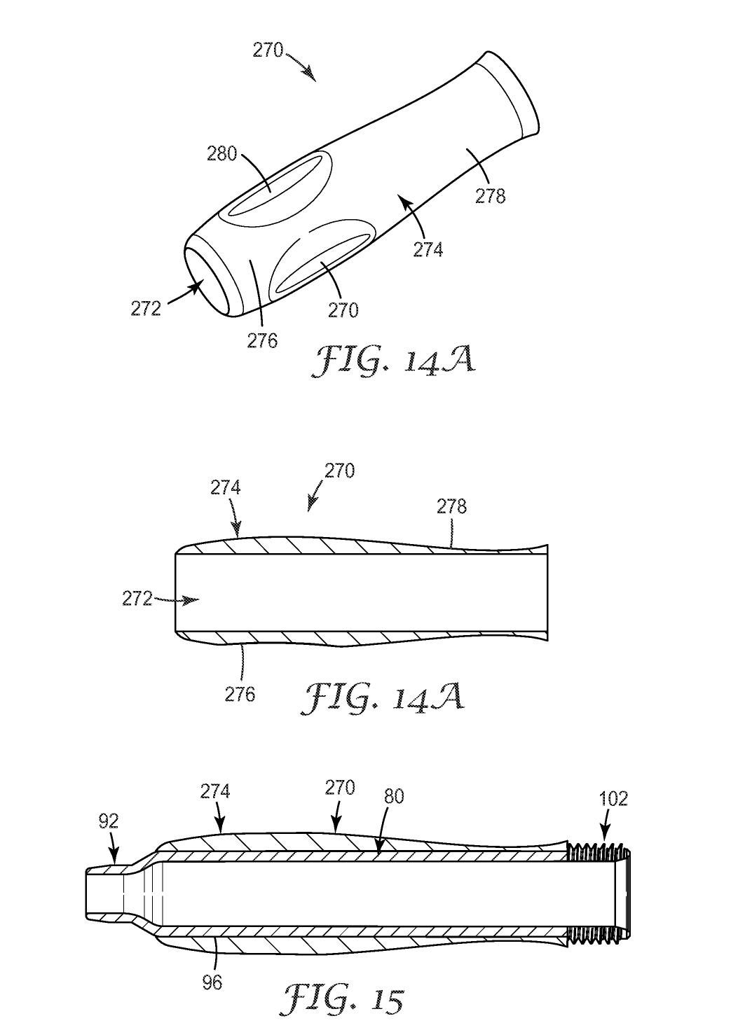

With the above in mind, one embodiment of an outer sleeve 270 configured for use with the universal barrel 80 (FIG. 3A) and representative of one of the first or second outer sleeves 34, 36 (FIG. 1) is shown in FIGS. 14A and 14B. The outer sleeve 270 is a tubular body defining a bore 272 configured for assembly over the universal barrel 80, and provides an outer handling surface 274. In some embodiments, the outer handling surface 274 defines a grasping region 276 and a labeling region 278. The grasping region 276 can form various features conducive to handling by a user, such as recessed grips 280 generally sized for ergonomic handling by a user's fingers. The labeling region 286 is relatively smooth for receiving a label or other printed material. Other attributes can be incorporated into the outer handling surface 274. Regardless, the outer handling surface 274 provides a look and tactile feel that differs from the simple cylinder associated with the universal barrel 80.

In some embodiments, the outer sleeve 270 can be formed of a relatively rigid material (e.g., molded plastic), and incorporates features that facilitate assembly over the universal barrel 80 (FIG. 3A). For example, with the relatively rigid construction, the bore 272 can be sized in accordance with an outer diameter of the universal barrel 80 to achieve a snap fit-type assembly. Other engagement features can further be incorporated into the outer sleeve 270 and the universal barrel 80.

Mounting of the outer sleeve 270 to the universal barrel 80 is illustrated in FIG. 15. As shown, the outer sleeve 270 encompasses or covers at least a majority of the universal barrel 80 such that a user handling the combined article will primarily interface with the outer handling surface 274 (as opposed to the exterior surface 96 of the universal barrel 80). The outer handling surface 274 provides a more ergonomically correct tactile feel and aesthetically pleasing look as compared to the universal barrel 80 alone. Notably, the outer sleeve 270 is sized and shaped in accordance with other features of the universal barrel 80, including the outer sleeve 270 not covering the exterior threaded surface 102 (or other plunger assembly coupling feature provided with the universal barrel 80) or the tip region 92.

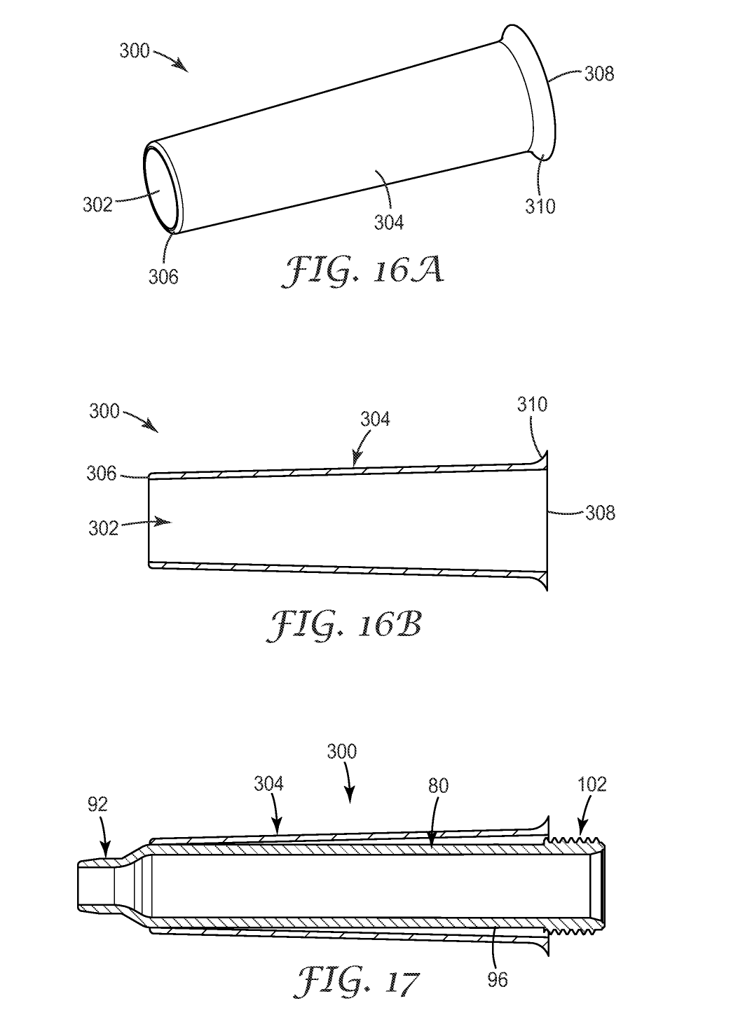

Another embodiment outer sleeve 300 configured for use with the universal barrel 80 (FIG. 3A) and representative of one of the first or second outer sleeves 34, 36 (FIG. 1) is shown in FIGS. 16A and 16B. The outer sleeve 300 can be highly akin to the outer sleeve 270 (FIG. 14A) described above, and is a tubular body defining a bore 302 and an outer handling surface 304. Once again, the outer sleeve 300 is configured for assembly over the universal barrel 80 (e.g., the bore 302 can provide a robust fit to the outer diameter of the universal barrel 80). The outer handling surface 304 can substantially smooth (i.e., free of texturing or overt contours), and defines an increasing outer diameter in extension from a first end 306 to a second end 308. In some embodiments, a flange 310 or similar body can be formed at the second end 308.

Mounting of the outer sleeve 300 to the universal barrel 80 is illustrated in FIG. 17. As shown, the outer sleeve 300 encompasses or covers at least a majority of a universal barrel 80 such that a user handling the combined article will primarily interface with the outer handling surface 304 (as opposed to the exterior surface 96 of the universal barrel 80). The outer handling surface 304 provides a more ergonomically correct tactile feel and aesthetically pleasing look as compared to the universal barrel 80 alone. Notably, the outer sleeve 300 is sized and shaped in accordance with other features of the universal barrel 80, including the outer sleeve 300 not covering the exterior threaded surface 102 (or other plunger assembly coupling feature provided with the universal barrel 80) or the tip region 92.

As a point of reference, a label (not shown) or similar printed material can be formed or applied on to the outer sleeves of the present disclosure. In other embodiment dental restorative material packaged articles of the present disclosure, the label or similar printed material is applied directly to the universal barrel 80 (i.e., a separate outer sleeve is not included). In yet other embodiments, information can be directly printed or laser marked on to the universal barrel, the outer sleeve, etc.

Caps Useful with the Universal Barrel 80

Returning to FIG. 1, in some embodiments of the present disclosure, the dental restorative material packaged article manufacturing system 20 and corresponding methods of manufacture further include the provision of a cap, with the supply 40 of caps optionally including two (or more) differently formatted cap constructions. Where provided, the caps and the loaded syringe barrels 24 have complementary features that facilitate their assembly. That is to say, the loaded syringe barrels 24 are universally designed for coupling with any of the available cap formats.

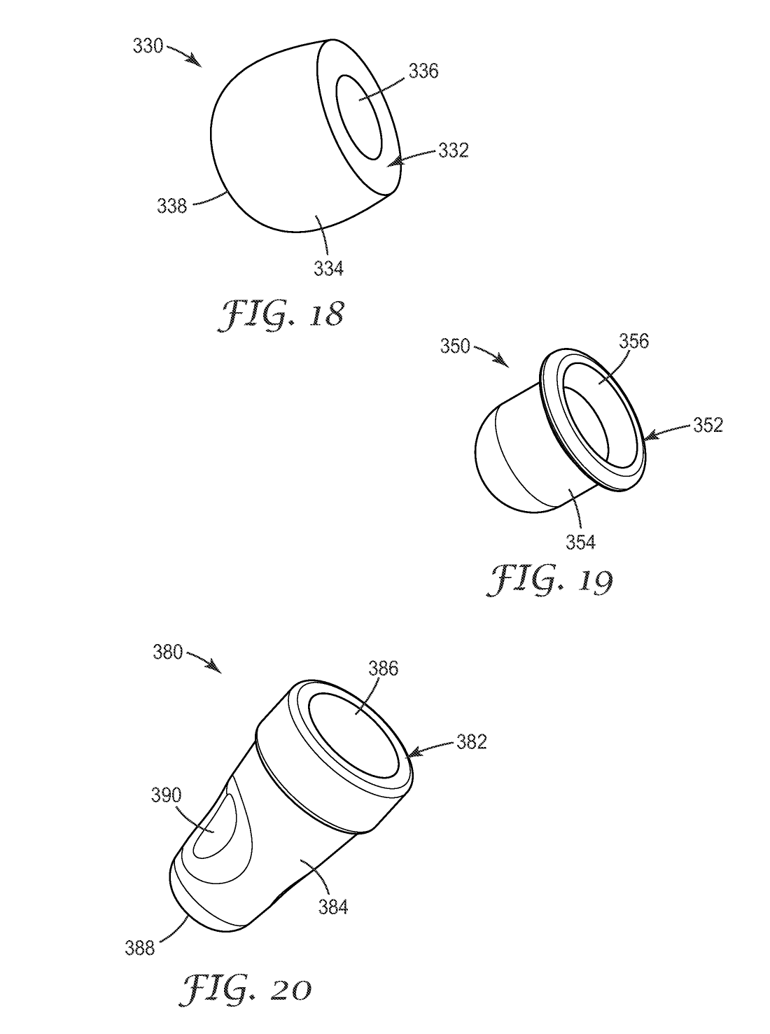

With the above in mind, one embodiment of a cap 330 configured for use with the universal barrel 80 (FIG. 3A) and representative of one of the first or second caps 40, 42 (FIG. 1) is shown in FIG. 18. The cap 330 defines a side 332 that can be relatively flat, and an exterior face 334 projecting from the side 332. An aperture 336 is formed through the side 332, and is sized and shaped in accordance with a size and shape of the tip region 92 (FIG. 3A) of the universal barrel 80 such that the tip region 92 can be frictionally captured within the aperture 336 upon final assembly (for example at the ridge 108 (FIG. 3A)). For example, a chamfer can be formed along the aperture 336 that corresponds with a tapering shape of the tip region 92. Other complimentary engagement features can alternatively be incorporated into the cap 330 and the universal barrel 80. The exterior face 334 can have the smooth, bulbous shape as shown, forming a curved edge 338 opposite the side 332. Alternatively, other surface features can be incorporated into the exterior face 334 that generate a differing aesthetic look and feel.

Another embodiment of a cap 350 configured for use with the universal barrel 80 (FIG. 3A) and representative of one of the first or second caps 40, 42 (FIG. 1) is shown in FIG. 19. The cap 350 is akin to the cap 330 (FIG. 18) described above, and defines a side 352 that can be relatively flat, and an exterior face 354 projecting from the side 352. An aperture 356 is formed through the side 352, and is sized and shaped in accordance with a size and shape of the tip region 92 (FIG. 3A) of the universal barrel 80 such that the tip region 92 can be frictionally captured within the aperture 356 upon final assembly (e.g., the aperture 356 can be shaped to match a taper of the tip region 92). Other complimentary engagement features can alternatively be incorporated into the cap 350 and the universal barrel 80. An aesthetic appearance of the exterior face 354 differs from that created by the exterior face 334 (FIG. 18) of the cap 330, thus giving the cap 350 a different look and feel. Alternatively, other surface features can be incorporated into the exterior face 354 that generate a differing aesthetic look and feel.

Another embodiment of a cap 380 configured for use with the universal barrel 80 (FIG. 3A) and representative of one of the first or second caps 40, 42 (FIG. 1) is shown in FIG. 20. The cap 380 is akin to the caps 330 (FIG. 18), 350 (FIG. 19) described above, and defines a side 382 that can be relatively flat, and an exterior face 384 projecting from the side 382. An aperture 386 is formed through the side 382, and is sized and shaped in accordance with a size and shape of the tip region 92 (FIG. 3A) of the universal barrel 80 (FIG. 3A) such that the tip region 92 can be frictionally captured within the aperture 386 upon final assembly (e.g., the aperture 386 can be shaped to match a taper of the tip region 92). Other complimentary engagement features can alternatively be incorporated into the cap 380 and the universal barrel 80. An aesthetic appearance of the exterior face 384 differs from that created by the exterior faces 334, 354 (FIGS. 18 and 19) described above, thus giving the cap 380 a different look and feel. For example, the exterior face 384 has a more streamlined shape in extension to a curved edge 388. Further, one or more recesses 390 can be formed in the exterior face 384, and provide a convenient area for grasping by a user's fingers. Alternatively, other surface features can be incorporated into the exterior face 384 that generate a differing aesthetic look and feel.

Exemplary Dental Restorative Material Packaged Article with Universal Barrel 80

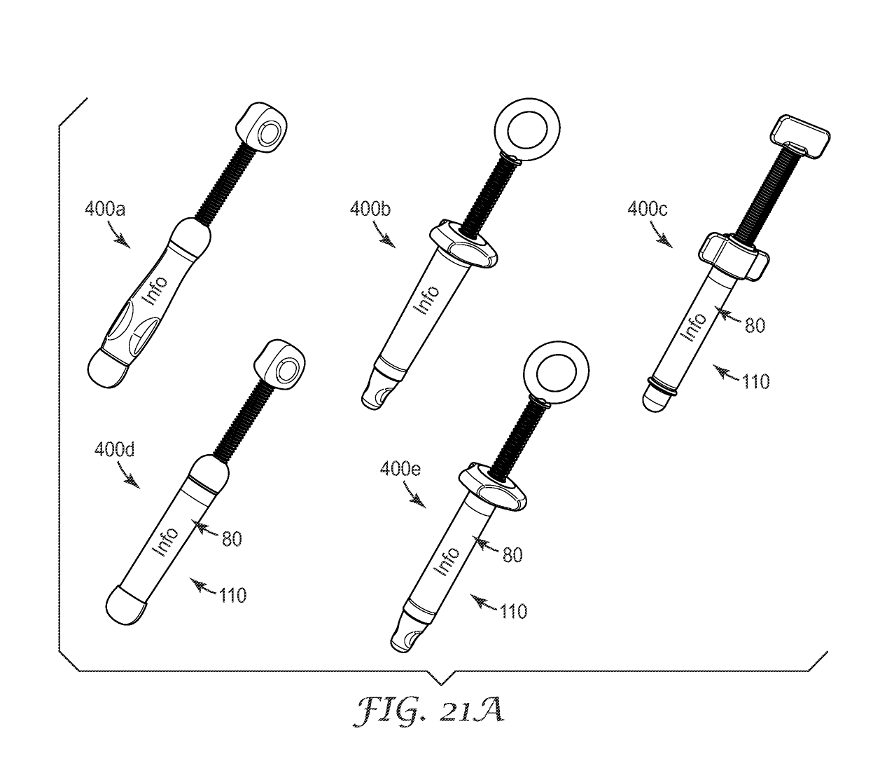

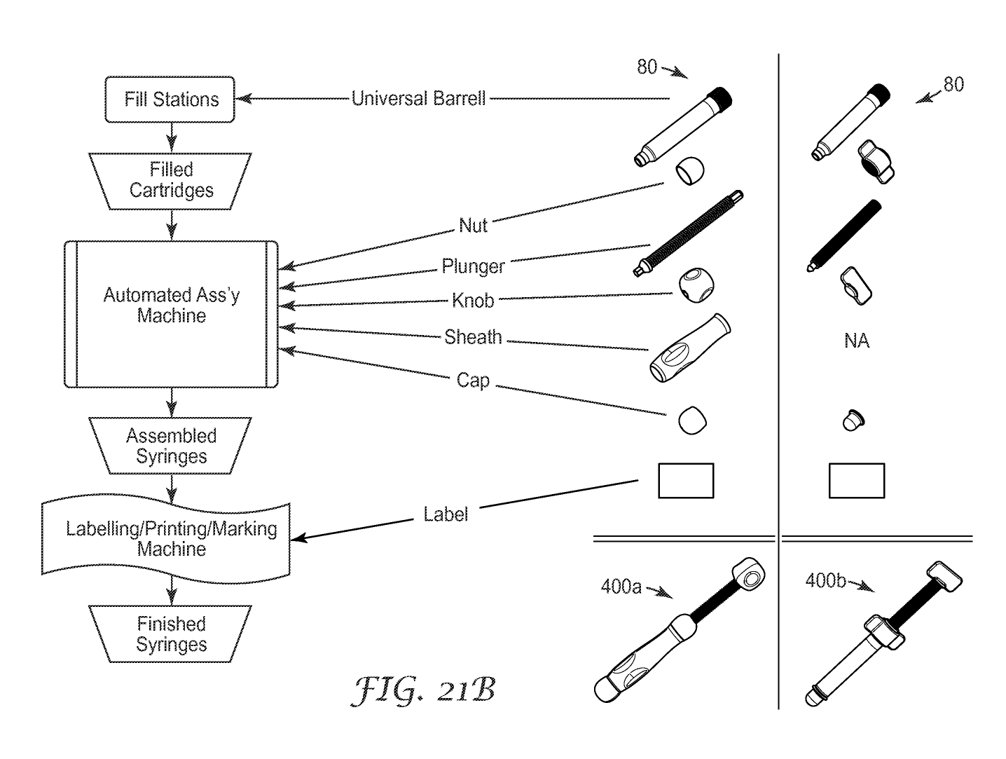

With the modular manufacturing systems and methods of the present disclosure, a plethora of differently formatted dental restorative material packaged articles can be created, for example on a mass production basis, all using the same loaded barrel 110, an in particular the universal barrel 80, several non-limiting examples of which are shown as packaged articles 400a -400e in FIG. 21A (it being understood that the universal barrel 80 provided with the packaged articles 400a, 400b is hidden). Each of the dental restorative material packaged articles 400a -400e is constructed around the common loaded barrel 110 (and thus each contains an identical dental restorative material (not shown)). In related embodiments, the manufacturing systems and methods further includes the manufacturer having a supply of the universal barrels 80 available, and filling a corresponding number of the universal barrels 80 with a dental restorative material implicated by each particular customer order. In other words, the exemplary packaged articles 400a -400e (and others) can store different dental restorative material formulations. Regardless, FIG. 21B schematically illustrates an exemplary modular manufacturing system of the present disclosure in manufacturing two of the packaged articles 400a, 400c from the same universal barrel 80.

### Alternative Universal Syringe Barrel Embodiments

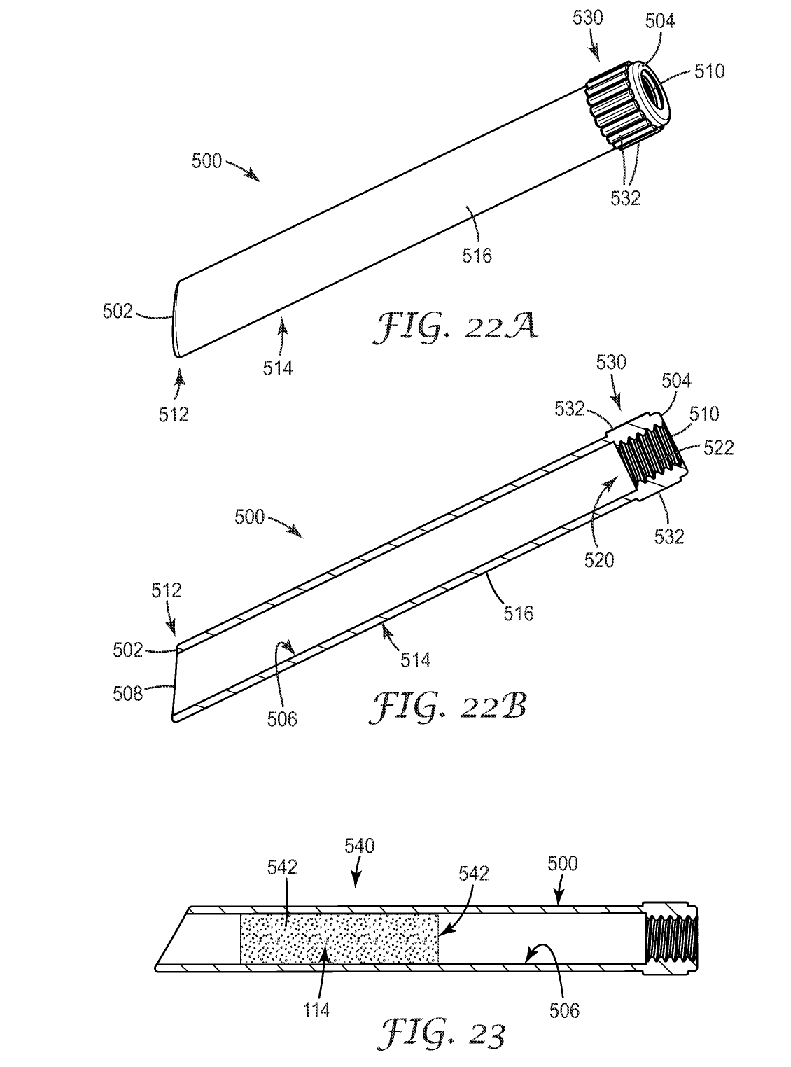

The universal syringe barrel 80 described above is but one configuration envisioned by the present disclosure. In other embodiments, the universal syringe barrel can incorporate differing and/or additional features, including a differently-formatted plunger coupling feature (with the plunger assemblies (and other optional components) utilized with the corresponding manufacturing systems and methods commonly configured to include a corresponding, complimentary coupling feature). For example, another embodiment universal syringe barrel 500 in accordance with principles of the present disclosure and useful as part of the loaded syringe barrel 24 (FIG. 1) is shown in FIGS. 22A-22B. The universal barrel 500 can be a homogeneous, integrally formed body and defines a leading end 502, a trailing end 504, and a chamber 506. The chamber 506 is sized and shaped to receive and contain a volume of dental restorative material (not shown), and extends between opening 508, 510 defined at the leading and trailing ends 502, 504, respectively. In some embodiments, the leading end 502 has a beveled cut or shape (i.e., is non-perpendicular relative to a central axis of the barrel 500).

The universal barrel 500 can have a generally cylindrical shape, for example generally defining a tip region 512 and a containment region 514. The tip region 512 extends from the leading end 502 and can have the same outer diameter as the containment region 514. In other embodiments, the tip region 512 can taper in diameter as with the universal syringe barrel 80 (FIG. 3A) described above. The containment region 514 can also be a simple cylinder in shape, with an exterior surface 516 thereof being substantially smooth or free of surface contours.

The universal barrel 500 further includes or defines a first or plunger coupling feature 520 adjacent the trailing end 504. The plunger coupling feature 520 is configured (in tandem with plunger assemblies (described below)) for engagement with a complimentary coupling feature commonly provided with the various plunger assemblies described below. In some embodiments, the plunger coupling feature 520 is an interior threaded surface 522 formed along the chamber 506. Alternatively, the plunger coupling feature 500 can assume a variety of other forms. In some constructions, though, the plunger coupling feature 520 is selected so as to be conducive to integral formation of the universal barrel 500 (e.g., a plastic molded part).

The universal barrel 500 optionally forms a second coupling feature 530 that can be adjacent the trailing end 504. Where provided, the second coupling feature 530 is generally configured for universal connection with any of the outer sleeves (described below) optionally provided with the corresponding manufacturing systems. With this in mind, the second coupling feature 530 can be a plurality of longitudinally extending splines 532 formed along the exterior surface 516. The splines 532 can project outwardly from the exterior surface 516 (e.g., the splines 532 collectively define a diameter that is greater than an outer diameter of a remainder of the universal barrel 500), and in some embodiments extends along only a partial length of the universal barrel 500. For example, the splines 532 can be formed immediately adjacent the trailing end 504, and have a longitudinal length on the order of no more than 25% of a total length of the universal barrel 500; alternatively, no more than 10% of the total length. Regardless, the splines 532 are uniformly spaced about a circumference of the universal barrel 500.

As shown in FIG. 23, a loaded syringe barrel 540 useful as the loaded syringe barrels 24 (FIG. 1) of the supply 22 (FIG. 1) can be formed by filling or loading a volume 542 of the dental restorative material 114 into the chamber 506. The universal barrel 500 can be formed of a material(s) selected to block light from interacting with the contained dental restorative material 114 with embodiments in which the dental restorative material 114 is radiation-reactive.

Plunger Assemblies Useful with the Universal Barrel 500

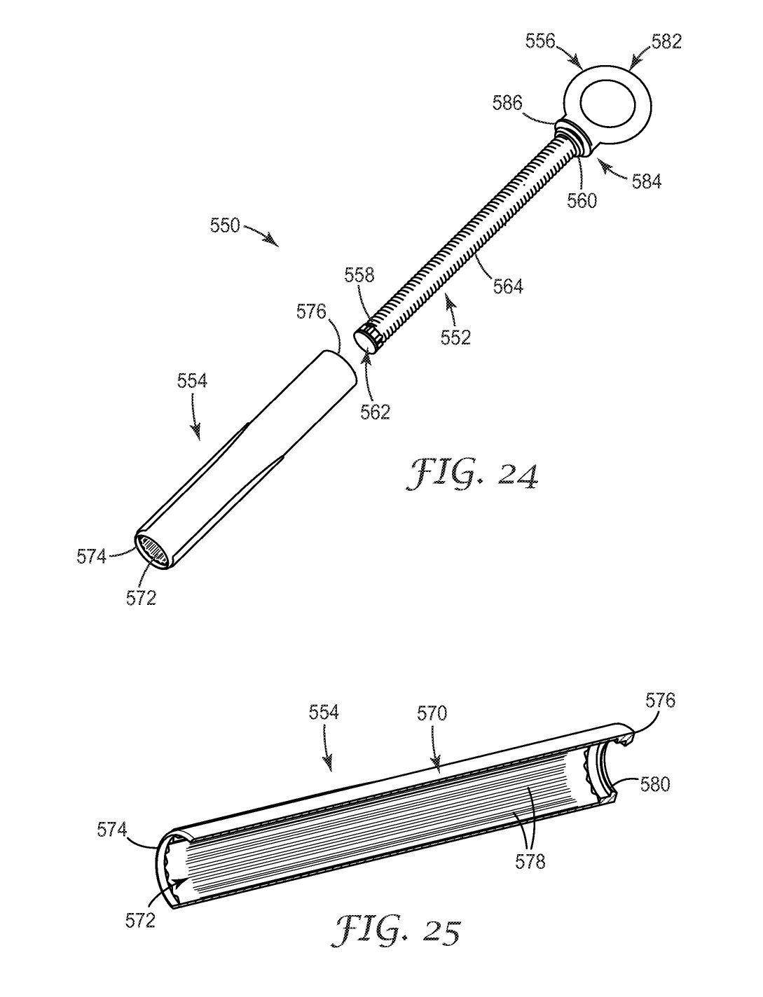

As with previous embodiments, where the manufacturing system 20 (FIG. 1) employs the loaded syringe barrel 540 with the supply 22 (FIG. 1) of loaded syringe barrels, the remaining components of the system 20 are configured in accordance with the coupling feature(s) provided with the universal barrel 500. For example, each of the first and second plunger assemblies 28, 30 (FIG. 1) commonly include a complimentary coupling feature configured to engage (e.g., threadably engage) the plunger coupling feature 520 (FIG. 22B). However, other features provided with the available plunger assemblies can incorporate a variety of other or differing designs. For example, FIG. 24 illustrates one embodiment of a plunger assembly 550 configured for use with the universal barrel 500 (FIG. 22A) and representative of one of the first or second plunger assemblies 28, 30. The plunger assembly 550 includes a plunger shaft 552, a first auxiliary device 554 and a second auxiliary device 556. As with previous embodiments, at least one of the plunger shaft 552 or the auxiliary devices 554, 556 forms a complimentary coupling feature configured to connect with the plunger coupling feature 520 provided with the universal barrel 500. With the exemplary embodiment of FIG. 24, the plunger shaft 552 incorporates the complimentary coupling feature as described below.

The plunger shaft 552 can assume various forms, and extends between a piston end 558 and a handle end 560 (referenced generally). The piston end 558 is configured for connection to, or alternatively forms, a piston member 562 in some embodiments. Conversely, the handle end 560 is configured for assembly to, or alternatively integrally forms, the second auxiliary device 556. Further, the plunger shaft 552 forms or defines an exterior threaded surface 564 that serves as the complimentary coupling feature of the plunger assembly 550. More particularly, the exterior threaded surface 564 is configured to threadably engage the interior threaded surface 522 (FIG. 22B) of the universal barrel 500 (FIG. 22A). The piston member 562 and/or the second auxiliary device 556 can be configured to threadably engage the exterior threaded surface 566 with final construction of the plunger assembly 550.

With additional reference to FIG. 25, the first auxiliary device 554 can be a sleeve or tubular body 570 defining a central passageway 572 extending between, and open at, first and second ends 574, 576. A plurality of longitudinally extending ribs 578 are formed along an interior surface of the sleeve 570, and in some embodiments extend along at least a majority of a total length of the sleeve 570. For example, the ribs 578 can terminate proximate the first and second ends 574, 576. The ribs 578 are equidistantly spaced from one another, with a circumferential spacing between adjacent ones of the ribs 578 corresponding with a circumferential width of each of the universal barrel splines 532 (FIG. 22A), and vice-versa. Further, an inner diameter of the sleeve 570 (along passageway 572) corresponds with (e.g., is slightly larger than) an outer diameter of the universal barrel 500 (FIG. 22A). With this complimentary construction, the sleeve 570 is configured to co-axially receive universal barrel 500, including the ribs 578 engaging the splines 532 in a manner permitting sliding between the components 500, 570 as described below.

A diameter of the passageway 572 is substantially uniform along a majority of the length of the sleeve 570. A reduced diameter is defined adjacent the second end 576, with the sleeve 570 further forming a circumferential lip 580 for reasons made clear below.

With specific reference to FIG. 24, the second auxiliary device 556 forms or provides a handle 582 and a base 584. The handle 582 is generally configured to promote user application of a moment or twisting force onto the plunger shaft 552 and can have the loop-like shape shown. A variety of other handle shapes or configurations are also acceptable. The base 584 is configured to maintain the handle 582 relative to the plunger shaft 552 and in some embodiments forms a slot 586. The slot 586 is sized and shaped in accordance with the circumferential lip 580 (FIG. 25), and facilitates a rotational coupling between the plunger shaft 552 and the sleeve 570 as described below.

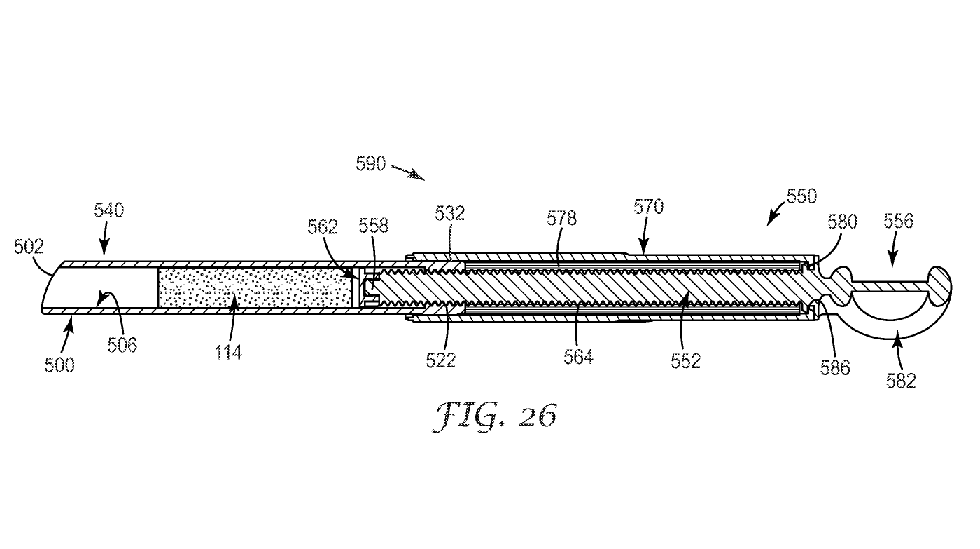

Final construction of the plunger assembly 550 and mounting to the loaded syringe barrel 540 is shown in FIG. 26, with the final assembly representing one embodiment of a dental restorative packaged article 590 in accordance with the present disclosure. The sleeve 570 is coupled to the second auxiliary device 556. More particularly, the circumferential lip 580 is captured within the slot 586. With this mounting technique, the second auxiliary device 556, and thus the plunger shaft 552 attached thereto, can freely rotate relative to the sleeve 570 (and vice-versa); however, longitudinal movement of the second auxiliary device 556, and thus the plunger shaft 552, is directly transferred on to the sleeve 570. That is to say, the sleeve 570 is caused to move in conjunction with a longitudinal movement of the plunger shaft 552. Further, the plunger shaft 552 is arranged relative to the universal barrel 500 such that the piston end 558 (and the optional piston member 562 attached thereto) is disposed within the chamber 506. Further, the complimentary coupling features of the universal barrel 500 and the plunger assembly 550 are engaged with one another, for example the exterior threaded surface 564 of the plunger shaft 552 threadably engaged with the interior threaded surface 522 of the universal barrel 500. Finally, the sleeve 570 is co-axially disposed relative to the universal barrel 500, with the splines 532 in meshed engagement with the longitudinal ribs 578. In the initial state of FIG. 26, only a small portion of the sleeve 570 is disposed over the universal barrel 500. A remainder of the sleeve 570 extends from the universal barrel 500 and covers the plunger shaft 552; the sleeve 570 thus creates a more pleasing aesthetic appearance to the packaged article 590.

With the above construction, the dental restorative material 114 can be progressively dispensed though the leading end 502 of the universal barrel 500 by user-prompted rotation of the plunger shaft 552 (e.g., via the handle 582) in a direction that causes the piston end 558 (and thus the piston member 562) to advance toward the leading end 502. In this regard, the plunger shaft 552 can freely rotate relative to the sleeve 570. However, as the plunger shaft 552 is caused to move longitudinally relative to the universal barrel 500, the sleeve 570 moves in a similar fashion due to the interface at the lip 580 within the slot 586. The meshed interface between the splines 532 and the ribs 578 allows the sleeve 570 to slide longitudinally relative to the universal barrel 500.

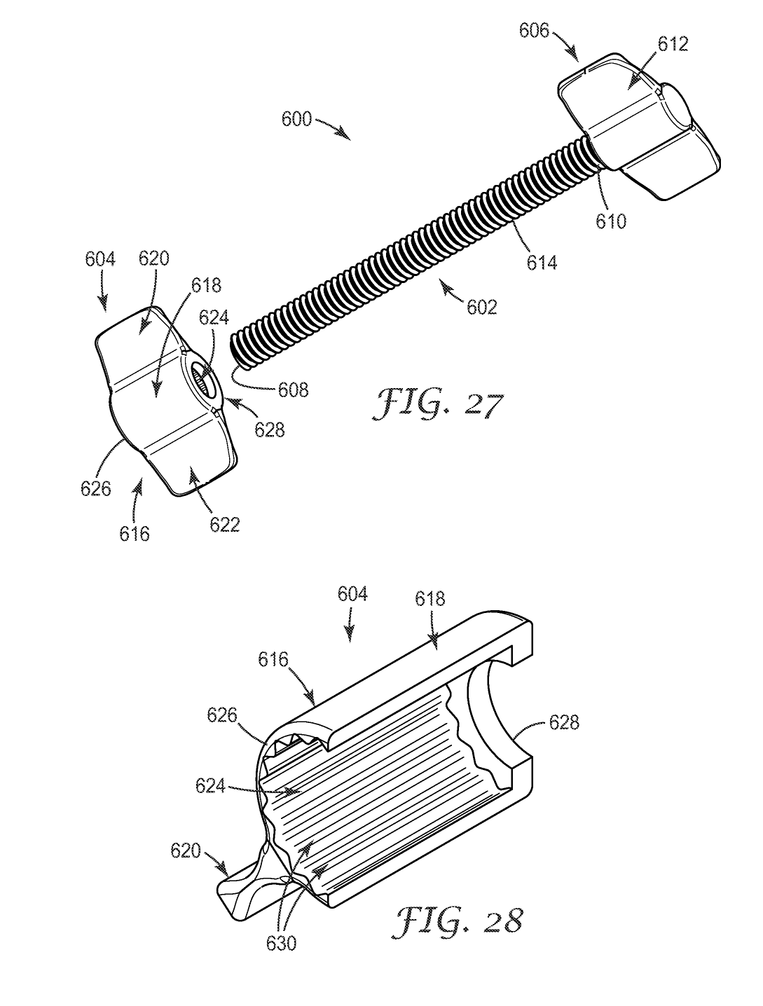

Another embodiment plunger assembly 600 configured for use with the universal barrel 500 (FIG. 22A) and representative of one of the first or second plunger assemblies 28, 30 (FIG. 1) is shown in FIG. 27. The plunger assembly 600 includes a plunger shaft 602, a first auxiliary device 604, and a second auxiliary device 606. At least one of the shaft 602 or the auxiliary devices 604, 606 forms or provides a complimentary coupling feature configured to connect with the plunger coupling feature 520 (FIG. 22A) provided with the universal barrel 500. With the exemplary embodiment of FIG. 27, the plunger shaft 602 incorporates the complimentary coupling feature as described below.

The plunger shaft 602 can be highly similar to the plunger shaft 552 (FIG. 24) described above, and extends between a piston end 608 and a handle end 610 (referenced generally). The piston end 608 optionally can form or is configured for connection to a piston member (not shown). The handle end 610 is configured for assembly to the second auxiliary device 606 that, in the one embodiment of FIG. 27, is a handle in the form of a flattened knob 612. Further, the plunger shaft 602 forms or defines an exterior threaded surface 614 that serves as the complimentary coupling feature of the plunger assembly 600. More particularly, the exterior threaded surface 614 is configured to threadably engage the interior threaded surface

With additional reference to FIG. 28, the first auxiliary device 604 can assume the form of a wing nut or wing nut-like body 616. The wing nut 616 includes or defines a central portion 618 and opposing fingers 620, 622. The fingers 620, 622 project form opposite sides of the central portion 618, and provide a convenient surface for grasping by a user. The central portion 618, in turn, forms a passageway 624 extending between, and open at, first and second ends 626, 628. A diameter of the passageway 624 at the first end 626 approximates (e.g., is slightly larger than) an outer diameter of the universal barrel 500 (FIG. 22A); at the second end 628, the diameter of the passageway 624 is less than the outer diameter of the universal barrel 500 and is greater than an outer diameter of the plunger shaft 602. A plurality of longitudinally extending ribs 630 are formed along an interior surface of the central portion 618, and in some embodiments extend along at least a majority of a total length of the passageway 624. For example, the ribs 630 can extend from the first end 626, and terminate away from the reduced-diameter second end 628. The ribs 630 are equidistantly spaced from one another, with a circumferential spacing between adjacent ones of the ribs 630 corresponding with a circumferential width of each of the universal barrel splines 532 (FIG. 22A), and vice-versa. With this complimentary construction, the wing nut 616 is configured to co-axially receive universal barrel 500, including the ribs 630 engaging the splines 532 as described below.

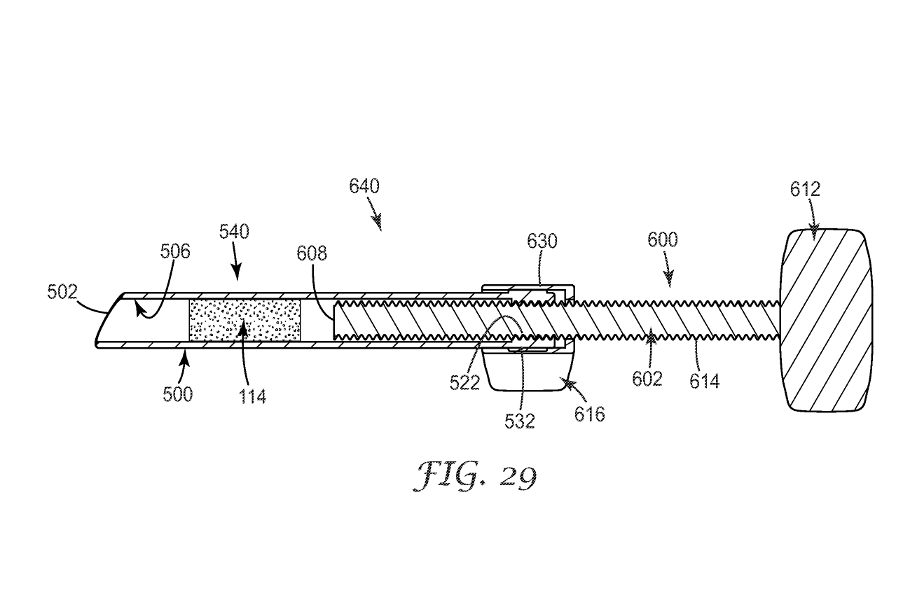

Final construction of the plunger assembly 600 and mounting to the loaded syringe barrel 540 is shown in FIG. 29, with the final assembly representing one embodiment of a dental restorative packaged article 640 in accordance with the present disclosure. The plunger shaft 602 is arranged relative to the universal barrel 500 such that the piston end 608 (and the optional piston member (not shown) attached thereto) is disposed within the chamber 506. Further, the complimentary coupling features of the universal barrel 500 and the plunger assembly 600 are engaged with one another, for example the exterior threaded surface 614 of the plunger shaft 602 threadably engaged with the interior threaded surface 522 of the universal barrel 500. Finally, the wing nut 616 is co-axially disposed over the universal barrel 500, with the splines 532 in meshed engagement with the longitudinal ribs 630. With this construction, the dental restorative material 114 can be progressively dispensed through the leading end 502 of the universal barrel 500 by user-prompted rotation of the plunger shaft 602 in a direction that causes the piston end 608 to advance toward the leading end 502. In this regard, the wing nut 616 provides convenient grasping surface for the user when applying the moment force to the plunger shaft 602 (via the knob 612).

Commensurate with the above explanations, alternative embodiments of the plunger assembly 600 can include the first auxiliary device 604 assuming different forms, for example a more elongated shape that encompasses a larger portion of the universal barrel 500 (e.g., akin to the outer sleeves described above). Further, a label (not shown) or similar printed material can be formed or applied to one or more of the universal barrel 500 and/or the plunger assemblies.

Additional Components Useful with the Universal Barrel 500

Returning to FIG. 1, in some embodiments of the present disclosure, the dental restorative material packaged article manufacturing system 20 and corresponding methods of manufacture further include the provision of a cap, with the supply 40 of caps optionally including two (or more) differently formatted cap constructions. With embodiments utilizing the universal syringe barrel 500 (FIG. 22A) as a component of each of the loaded syringe barrels 24, the caps (where provided) and the universal syringe barrels 500 have complimentary features that facilitate their assembly. Any of the cap embodiments described above can be useful with the universal barrel 500. Similarly, outer sleeves akin to the outer sleeves described above can be provided, as can labels. Other, additional components can also be available for assembly to the universal barrel 500.

Exemplary Dental Restorative Material Packaged Article with Universal Barrel 500

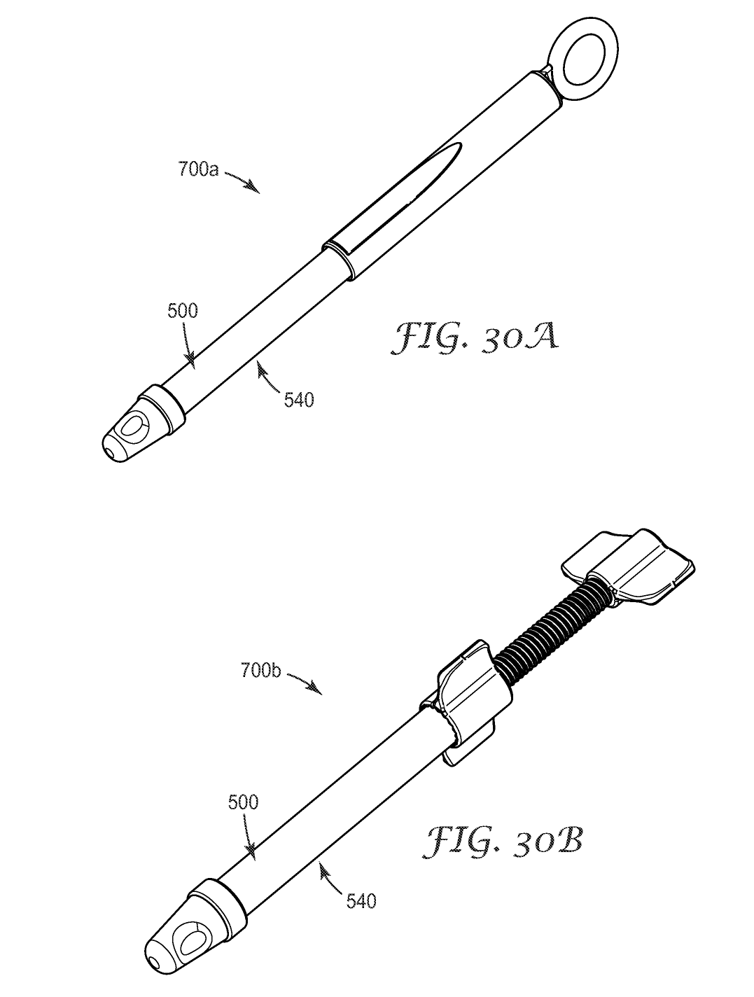

With the modular manufacturing systems and methods of the present disclosure, a plethora of differently formatted dental restorative material packaged articles can be created, for example on a mass production basis, all using the same loaded syringe barrel 540, and in particular the universal barrel 500, several non-limiting examples of which are shown as packaged articles 700a, 700b in FIG. 30. Each of the dental restorative material packaged articles 700a, 700b is constructed around the common loaded barrel 540 (and thus each contains an identical dental restorative material (not shown)). In related embodiments, the manufacturing systems and methods further includes the manufacturer having a supply of the universal barrels 500 available, and filling a corresponding number of the universal barrels 500 with a dental restorative material implicated by each particular customer order. In other words, the exemplary packaged articles 700a, 700b (and others) can store different dental restorative material formulations.

### Optional Fullness Indicator

As evidenced by the above descriptions, the modular dental restorative material packaged article manufacturing systems and methods can utilize a variety of different universal barrel configurations, with the designs of the remaining components comprising the resultant packaged articles also being highly flexible so long as coupling features complimenting those of the particular universal barrel design are implemented. Thus, the present disclosure is not limited to any of the specific, exemplary embodiments discussed above. In addition, other features, such as a fullness indicator, can be incorporated into the dental restorative material packaged articles that may or may not be conducive to the modular manufacturing techniques.

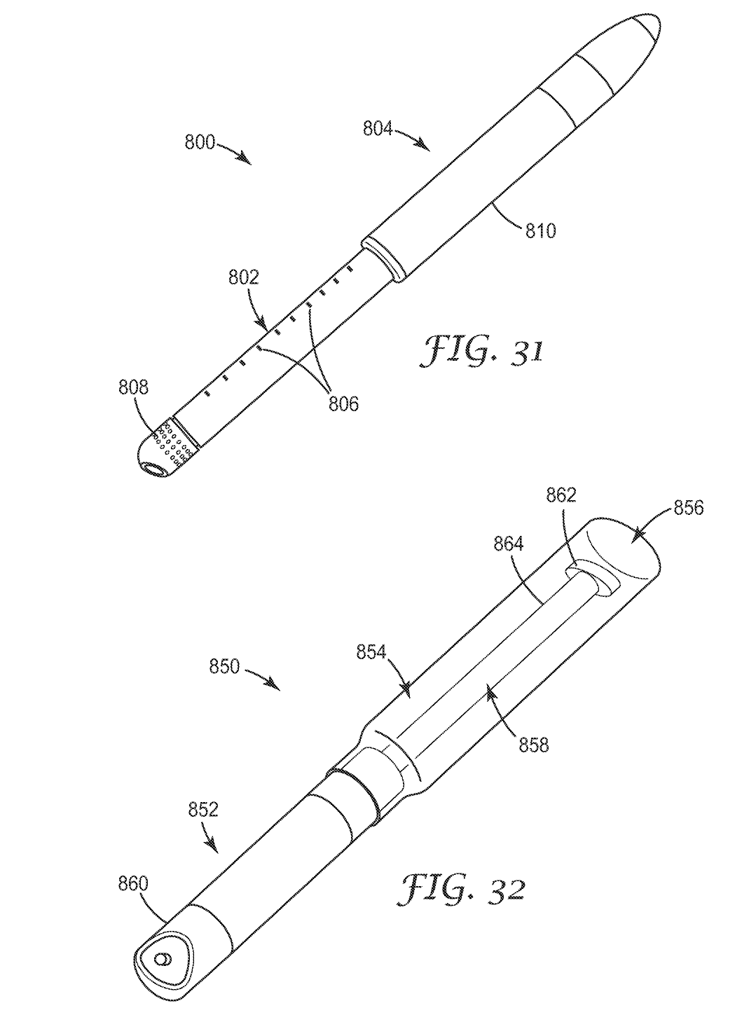

For example, FIG. 31 illustrates another dental restorative material packaged article 800 akin to the packaged article 590 of FIG. 26, and generally includes a barrel 802 and a plunger assembly 804 (referenced generally). The barrel 802 can be a generally cylindrical body forming a chamber (not shown) containing a volume of dental restorative material (not shown). Indicia 806 is applied or formed on an exterior surface of the barrel 802, and conveys information indicative of a volume of material within the chamber. The plunger assembly 804 is connected to the barrel 802, and is operable to cause progressive dispensing of the contained dental restorative material from a leading end 808 of the barrel 802. For example, the plunger assembly 804 can be similar to the plunger assembly 550 (FIG. 24) described above, and generally includes a plunger shaft (not shown) having a plunger end (not shown) located within the chamber. An outer sleeve 810 is also included, and is connected to the plunger shaft (e.g., akin to the connection between the plunger shaft 552 and the sleeve 570 in FIG. 25 described above). With the embodiment of FIG. 31, the sleeve 810 is substantially opaque, and can have a dark color that contrast with a color of the barrel 802. As the plunger assembly 804 is actuated to dispense material, the outer sleeve 810 slides along the barrel 802, progressively covering portions of the indicia 806. The volumetric information embodied by the indicia 806 is graduated in accordance with the progressive action, such that the indicia 806 still visible “beyond” the outer sleeve 810 readily informs the user as to how much of the dental restorative material remains in the packaged article 800.

The optional fullness indication feature described above can be provided in other forms. For example, another related embodiment dental restorative material packaged article 850 is shown in FIG. 32, and generally includes a barrel 852, a plunger assembly 854 (referenced generally) and a cover 856. The barrel 852 contains a volume of dental restorative material (not shown). The plunger assembly 854 includes a plunger shaft 858, and is connected to the barrel 852 such that material is progressively dispensed from a leading end 860 of the barrel with rotation of the plunger shaft 858. The plunger shaft 858 terminates at a handle 862 opposite the barrel 852. The cover 856 is configured to be selectively connected to the barrel 852, and disposed over that portion of the plunger shaft 858 extending from the barrel 852. The cover 856 is substantially transparent (e.g. the plunger shaft 858 is visible through the cover 856). Indicia 864 (referenced generally) is applied to or formed on the cover 856, and conveys scaled information indicative of a volume of material within the barrel's chamber. A user can thus gauge the amount of material remaining in the barrel 852 by the length of the plunger shaft 858, for example by correlating or matching a location of the handle 862 relative to the scaled indicia 864.

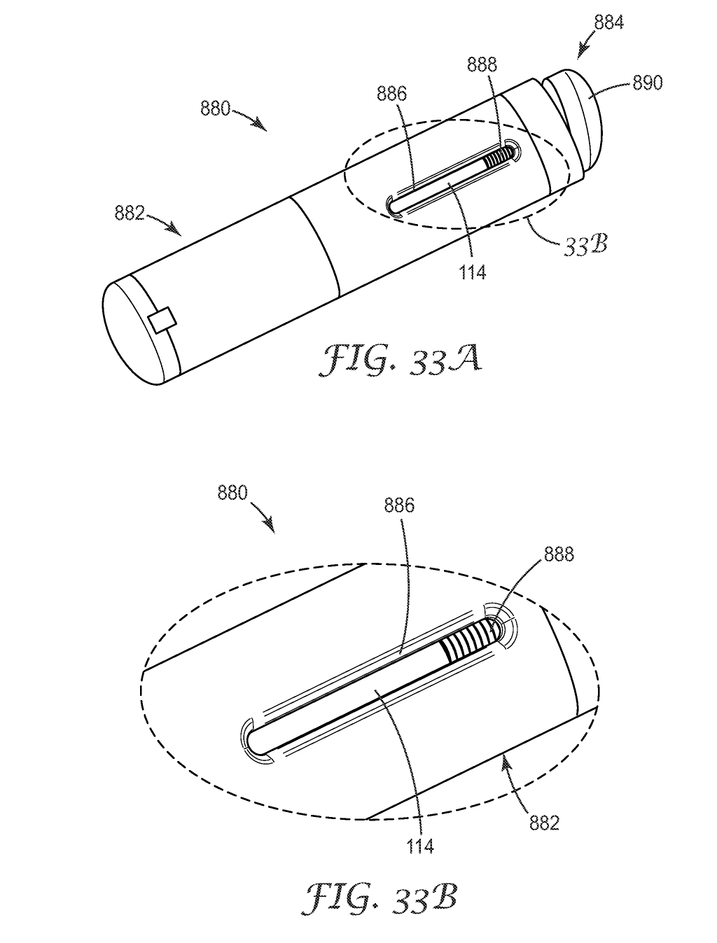

Another related embodiment dental restorative material packaged article 880 is shown in FIG. 33A and 33B, and generally includes a barrel 882 and a plunger assembly 884 (referenced generally). The barrel 882 forms a chamber (not shown) and a window 886. The window 886 is substantially transparent, facilitating viewing of the contents of the chamber from an exterior of the barrel 882. A volume of the dental restorative material 114 (visible in FIGS. 33A and 33B through the window 886) is contained in the chamber. The plunger assembly 884 generally includes a plunger shaft 888 (visible in FIGS. 33A and 33B through the window 886) and an actuator 890. The plunger shaft 888 is connected to the actuator 890 such that rotation of the actuator 890 advances/retracts the plunger 888 relative to the barrel 882. In some embodiments, the plunger assembly 884 is configured such that an overall length of the packaged article 880 does not change during use (i.e., a longitudinal position of the actuator 890 relative to the barrel 882 does not change with movement of the plunger shaft 888). Regardless, a color of the plunger shaft 888 differs from a color of the dental restorative material 114 (e.g., the dental restorative material 114 can be white, whereas the plunger shaft 888 is a dark color such as black). When viewing the contrasting colors through the window 886, a user can readily estimate a volume of the dental restorative material 114 remaining in the barrel 882. In particular, as the plunger assembly 884 is operated to progressively dispense material from the barrel 882, the plunger shaft 888 will progressively occupy an increasing portion of the window 886. Stated otherwise, the user can directly “see” how much of the dental restorative material 114 remains in the barrel 882 by simply looking at the window 886.

Although the present disclosure has been described with reference to preferred embodiments, workers skilled in the art will recognize that changes can be made in form and detail without departing from the spirit and scope of the present disclosure. For example, while several embodiments discussed above employ threaded-type connections between various components, other mounting configurations are envisioned and equally acceptable. Thus, the threaded connections can instead be adhesives, snap fit, press fit, welding (e.g., laser, friction, ultrasonic), etc.

What is claimed is:

1. A method of manufacturing dental restorative material packaged articles, the method comprising:
selecting a first loaded syringe barrel from a plurality of loaded syringe barrels, each including:
a barrel defining a leading end, a trailing end, and a chamber, the barrel including a plunger coupling feature adjacent the trailing end,
a volume of dental restorative material stored within the chamber;
selecting a first desired plunger assembly from a plurality of first plunger assemblies and a plurality of second plunger assemblies;
wherein each of the first plunger assemblies includes:
a first plunger shaft,
a first plunger auxiliary device,
wherein at least one of the first plunger shaft and auxiliary device provides
a first complimentary coupling feature configured to selectively engage the plunger coupling feature;
wherein each of the second plunger assemblies includes:
a second plunger shaft,
a second plunger auxiliary device;
wherein at least one of the second plunger shaft and auxiliary device provides the first complimentary coupling feature;
wherein each of the first plunger assemblies differs from each of the second plunger assemblies by at least one of:
the first plunger shaft differs from the second plunger shaft,
the first plunger auxiliary device differs from the second plunger auxiliary device; and
assembling the first desired plunger assembly to the first loaded syringe barrel, including engaging the corresponding plunger coupling feature with the corresponding first complimentary coupling feature, to provide a first dental restorative material packaged article operable to dispense dental restorative material from the corresponding leading end by manipulation of the corresponding plunger assembly.

2. The method of claim 1, wherein:
the plunger coupling feature is an interior threaded surface formed on each of the barrels.

3. The method of claim 2, wherein the first complimentary engagement feature is an exterior threaded surface formed on each of the first and second plunger shafts.

4. The method of claim 3, wherein each of the first and second plunger auxiliary devices is a handle attached to the corresponding plunger shaft.

5. The method of claim 3, wherein each of the barrels further forms a second coupling feature apart from the plunger coupling feature, and further wherein each of the first and second plunger auxiliary devices is a sleeve configured to selectively mate with the second coupling feature, and even further wherein the sleeve of each of the first plunger assemblies differs from the sleeve of each of the second plunger assemblies.

6. The method of claim 3, wherein the first plunger assembly further includes a piston member assembled to the corresponding first plunger shaft, and further wherein the second plunger assemblies do not include a piston member.

7. The method of claim 1, wherein the plunger coupling feature is an exterior threaded surface formed on each of the barrels.

8. The method of claim 7, wherein the first complimentary coupling feature is an interior threaded surface formed on each of the first and second plunger auxiliary devices.

9. The method of claim 8, wherein each of the first and second plunger auxiliary devices further forms a shaft engagement feature configured to selectively engage the corresponding plunger shaft.

10. The method of claim 9, wherein the shaft engagement feature is an interior threaded surface, and further wherein each of the shafts forms an exterior threaded surface configured to threadably engage the interior threaded surface of the corresponding plunger auxiliary device.

11. The method of claim 1, further comprising:
selecting a cap; and
assembling the selected cap to the leading end of the first loaded syringe barrel.

12. The method of claim 11, wherein the step of selecting a cap includes:
choosing a desired cap from a plurality of first caps and a plurality of second caps, each of the first caps differing from each of the second caps.

13. The method of claim 1, further comprising:
selecting an outer sleeve; and
applying the selected outer sleeve to an exterior of the first loaded syringe barrel.

14. The method of claim 13, wherein the step of selecting an outer sleeve includes choosing a desired outer sleeve from a plurality of first outer sleeves and a plurality of second outer sleeves, each of the first outer sleeves differing from each of the second outer sleeves.

15. The method of claim 14, wherein each of the first outer sleeves forms a contoured outer surface.

16. The method of claim 1, wherein the step of selecting a first desired plunger assembly includes:
reviewing an order for a dental restorative material packaged article; and
determining whether the received order implicates the first plunger assembly or the second plunger assembly.

17. The method of claim 1, wherein the first desired plunger assembly is one of the first plunger assemblies, the method further comprising:
assembling one of the second plunger assemblies to a second loaded syringe barrel to form a second dental restorative material packaged article.

18. The method of claim 17, further comprising:
forming a plurality of the first dental restorative material packaged articles; and
forming a plurality of the second dental restorative material packaged articles.

19. The method of claim 18, further comprising:
delivering the plurality of first dental restorative material packaged articles to a first customer; and
delivering the plurality of second dental restorative material packaged articles to a second customer.

20. A system for manufacturing dental restorative material packaged articles, the system comprising:
a plurality of loaded syringe barrels, each including:
a barrel defining a leading end, a trailing end, and a chamber, the barrel including a plunger coupling feature adjacent the trailing end,
a volume of dental restorative material stored within the chamber;
a plurality of first plunger assemblies, each including:
a first plunger shaft,
a first plunger auxiliary device,
wherein at least one of the first plunger shaft and auxiliary device provides a first complimentary coupling feature configured to selectively engage the plunger coupling feature; and
a plurality of second plunger assemblies, each including:
a second plunger shaft,
a second plunger auxiliary device;
wherein at least one of the second plunger shaft and auxiliary device provides the first complimentary coupling feature;
wherein each of the first plunger assemblies differs from each of the second plunger assemblies by at least one of:
the first plunger shaft differs from the second plunger shaft,
the first plunger auxiliary device differs from the second plunger auxiliary device;
wherein the system is configured such that any of the first plungers assemblies can be assembled to any of the loaded syringe barrels, and any of the second plunger assemblies can be assembled to any of the loaded syringe barrels, including engagement between the corresponding plunger coupling feature a the corresponding first complimentary coupling feature, to provide a dental restorative material packaged article operable to dispense dental restorative material from the corresponding leading end by manipulation of the corresponding plunger assembly.
